(19) United States
(12) Patent Application Publication
(10) Pub. No.: US 2022/0101342 A1
(43) Pub. Date: Mar. 31, 2022

(54) RISK/REWARD SCORING IN TRANSACTIONAL RELATIONSHIPS

(71) Applicant: FIDELIQi LLC, Reston, VA (US)

(72) Inventors: Timothy Jon MCGUCKIN, Reston, VA (US); Jeffrey WOLFF, Herndon, VA (US); Karon RICKER, Herndon, VA (US)

(21) Appl. No.: 17/422,054

(22) PCT Filed: Jan. 13, 2020
(86) PCT No.: PCT/US20/13411

§ 371 Date: Jul. 9, 2021

Related U.S. Application Data
(60) Provisional application No. 62/791,131, filed on Jan. 11, 2019.

(51) Int. Cl. G06Q 30/00; G06Q 30/02; G06N 20/00

(52) U.S. Cl. CPC G06Q 30/0185; G06N 20/00; G06Q 30/0201; G06Q 30/0282

(57) ABSTRACT

Systems and methods for risk/reward scoring in transactional relationships are disclosed and generally comprise entrant traits, entrant factors, entrant outcomes, predictive modeling, and subscriber and application-specific modeling and scoring with enforced anonymity and data privacy rules. A risk/reward scoring system may comprise a two-tier modeling and scoring architecture wherein a first tier comprises a platform predictive intelligence model and a second tier comprises an application models tier. The first tier can output a platform predictive intelligence entrant vector based on a statistical, probabilistic and predictive intelligence comprised in a majority or all of the entrant traits, entrant factors and entrant outcomes encompassing a plurality of risk/reward scoring applications. The second tier can output statistical, probabilistic and predictive outcomes providing a risk/reward score comprising evaluative considerations and measures useful in evaluating an application-specific potential transaction in view of the entity presenting the transaction opportunity.

### FIELD OF THE DISCLOSURE

The subject matter of this disclosure generally relates to systems and methods for scoring a potential transaction with an individual or other entity, and more specifically relates to systems and methods for risk/reward scoring in transactional relationships comprising entrant traits, entrant factors, entrant outcomes, predictive modeling, and subscriber and application-specific modeling and scoring with enforced anonymity and data privacy rules.

### BACKGROUND

Ideally with the presentation of a potential transaction with an individual or other entity, also referred to as a transactional entity, an evaluation of the merits of the potential transaction takes place. Generally, the merits of a potential transaction depend on the transactional entity and the application-specific details of the transaction itself. Ideally, an evaluation would involve a number of evaluative considerations, such as, the legitimacy of the transactional entity, the intent or intention of the transactional entity, the capacity of the transactional entity and the expected outcome of the transaction in view of the transactional entity. Provided with a sufficient account of these evaluative considerations of a potential transaction, an individual or other entity presented with a potential transaction, also referred to as an evaluating entity, may better assess the risks and rewards associated with the potential transaction in view of the transactional entity. This account of evaluative considerations as disclosed herein can be referred to as a risk/reward score in a transactional relationship.

For clarity, a few definitions will be provided or restated at this point and may be restated later to provide additional clarity of this disclosure:
Entity: Any individual or group, where group may be any of, but not limited to, an organization, association, agency, assembly or gathering, and may be exemplified by, but not limited to, a business organization or association, a government agency or a social organization, assembly or gathering, wherein such an individual or group is capable of interaction with another individual or group.
Transaction: An interaction between an individual or other entity, or any combination thereof.
Transactional Entity: An individual or other entity presenting or otherwise associated with a potential transaction.
Transactional Relationship: A transaction in view of a given transactional entity with which the transaction is being evaluated, entered into or has been entered into.
Evaluating Entity: An individual or other entity evaluating the merits of a potential transactional relationship.
Risk/Reward: Abbreviation for risk and reward.
Entrant: A transactional entity that has been entered into or is otherwise comprised within a risk/reward scoring system.
Member: An entrant which has a membership with a risk/reward scoring system.
Applicant: An entrant which does not have a membership with a risk/reward scoring system.
Subscriber: An evaluating entity utilizing a risk/reward scoring system.
Evaluative Consideration: A consideration, that when known, is beneficial to evaluating the merits of a potential transaction and may be, or be comprised of, one or more evaluative measures.
Evaluative Measure: A quantifiable, qualifiable or acknowledgeable evaluative consideration, or facet thereof, which may comprise one or more indicators which may be numeric, and which may be statistical, probabilistic or predictive indicators. The evaluative measure may further comprise an indication related to a confidence level of one or more indicators.
Risk/Reward Score: One or more evaluative considerations and/or evaluative measures, or a formatted result and/or a summary thereof, some of which may be statistical, probabilistic or predictive in nature and comprise measures of potential outcomes, generated for and relating to a potential transaction in view of a transactional relationship with an entrant. May also be referred to as a risk/reward score in a transactional relationship, a risk/reward score in view of a transactional relationship with an entrant or transactional entity, a risk/reward score for an entrant or an entrant risk/reward score.
Entrant Data Profile: A profile comprised of information associated with an entrant such as that relating to, but not limited to, informational, behavioral, historical and situational events, aspects, biometrics, images, writings, recordings, media, facts, representations, references and prior, current and potential transactions.
Entrant Feature Profile: A profile comprised of entrant traits, entrant factors and entrant outcomes which generally has been extracted from an entrant data profile.
Entrant Traits: Generally a plurality of (but can be solitary) distinguishing characteristics or qualities which may provide a behavioral representation of an entrant.
Entrant Factors: Generally a plurality of (but can be solitary) situational and historical events, aspects, facts, representations and references, each of which may relate to an entrant, a potential transaction or an entrant and a previous, current or potential transaction.
Entrant Outcomes: Generally a plurality of (but can be solitary) results such as those relating to previous transactional relationships, activities, events and actions of an entrant.

The internet can remove face-to-face interaction and handshake assurances between transacting parties, and therefore can obfuscate or eliminate many prior, pre-internet methods of evaluating the merits of a potential transaction with an individual or entity. When a transaction is presented through the internet, determining evaluative measures of evaluative considerations such as legitimacy, intent or intention, capacity and expected outcome can be both challenging and critical. Due to the anonymous nature of the internet, there is a prevalence of fraudulent activity generated by imposters, identity thieves, misrepresented individuals and entities, and nefarious parties. This has been an ongoing issue for measuring legitimacy in a transactional entity for a transaction comprising internet based interaction. As a result, systems and methods have been created to validate, verify and/or authenticate identity data, either given, extracted or inferred in a transaction, and assign a score, characterization, or comparison to a predetermined threshold level indicating an evaluative measure of legitimacy of the transactional entity.

The intent or intention, which may be used interchangeably throughout this disclosure, of the transactional entity can be particularly hard to measure given the anonymous nature of the internet, which unfortunately provides an environment for illegal, harmful or otherwise malicious activity, and which can present tremendous risk to other individuals and other entities engaged in transactions on the internet. Malicious intent can be enabled and/or automated through programmatic based methods such as through malware, including viruses, trojans, worms and bots, or accomplished through more direct methods of human activity. As a result, systems and methods have been created to monitor activity for malicious intent associated with internet based transactions, and in many cases assign thereto a quantifying score, characterization, or comparison to a predetermined threshold level, and therefore provide an evaluative measure of intent of the transactional identity. While this provides at least some measure of the malicious intent of a transactional entity, other intentions of transactional entities largely go unmeasured.

A potential transaction may be presented by a transactional entity with which an evaluating entity may have little or no experience, or no recent or relevant experience, which can be used to consider a potential transactional relationship. Systems which can provide a measure of capacity with regard to a transactional entity's ability and record of prior performance and follow-through have been developed. However these systems are generally agnostic to the details or application of the presented transaction. One such system is the FICO credit score system.

Systems and methods that measure legitimacy of a transactional entity, malicious intent of a transactional entity or capacity of a transactional entity are generally measuring details of the transactional entity or details comprising the presentation of a transaction by a transactional entity, and not details of the transaction itself In other words, many times there is an agnostic view to details of the transaction, and rather, a more narrow view centered on the transactional entity. Some systems contain rules and policies to be followed to reflect aspects related to a transaction. For example, an evaluating entity accessing an identity management system used for measuring the legitimacy of an identity presented by a transactional entity, may have a pre-established rule in which the level of identity verification, validation and authentication performed by the identity management system is a function of the monetary basis of the transaction. While this at least provides a rules-based linkage between the level of evaluative measures determined for the legitimacy of a transactional entity and details of a transaction, what is needed is a system and method for providing a more complete and sufficient scoring of measures of evaluative considerations including statistical, probabilistic and predictive measures of potential outcomes of a transaction in view of a transactional entity, which thereby provides a risk/reward score of a potential application-specific transaction in view of a transactional relationship with a specific transactional entity. This score can be referred to as a risk/reward score in a transactional relationship, or simply a risk/reward score.

### SUMMARY

The following brief summary of the invention may relate exemplary embodiments intended to provide an illustrative summary as an introduction to a subsequent detailed description of the invention.

Various embodiments of risk/reward scoring systems and various embodiments of methods for risk/reward scoring in transactional relationships are disclosed. In some embodiments the risk/reward systems may comprise entrant traits, entrant factors, entrant outcomes, predictive modeling, and subscriber and application-specific modeling and scoring with enforced anonymity and data privacy rules. An entity, which may be for example, a business entity, governmental entity, social entity or an individual entity (a person), may as an evaluating entity, submit a risk/reward score request to a risk/reward scoring system to score a potential transaction in view of a transactional entity in order to evaluate a potential or ongoing relationship therewith. An evaluating entity may submit a risk/reward score request to a risk/reward scoring system following receipt of a transaction request from a transactional entity, which may be new to them or with which they may have an existing relationship. Transactional entities being submitted for scoring may have a membership relationship with a risk/reward scoring system, and as such may also be referred to as a member. Those being submitted for scoring and not having a membership relationship with a risk/reward scoring system may be referred to as an applicant. Collectively, members and applicants once submitted by an evaluating entity for scoring and entered into a risk/reward scoring system, or otherwise comprised therein, may be referred to as entrants in the risk/reward scoring system.

A risk/reward scoring system may generate a risk/reward score providing evaluative measures relating to evaluative considerations, which may facilitate an evaluation by an evaluating entity of a risk/reward potential for a transaction in view of a transactional entity. These evaluative measures may relate to such evaluative considerations as legitimacy of the transactional entity, intent of the transactional entity, the capacity of the transactional entity and potential outcomes of the transaction in view of the transactional entity. Evaluative measures may comprise one or more indicators which may be numeric, and which may be statistical, probabilistic or predictive indicators. Evaluative measures may further comprise an indication related to a confidence level of one or more indicators. Each evaluative consideration may have one or more associated evaluative measures which may be generated by the risk/reward scoring system, and such generation may be due, at least in part, in relation to an application-specific transaction for which the risk/reward score is being generated.

A risk/reward scoring system may comprise an entrant data manager, a feature extraction engine, a risk/reward scoring engine and a risk/reward modeler. A risk/reward scoring system may comprise information associated with an entrant, such as that relating to, but not limited to informational, behavioral, historical and situational events; aspects, biometrics, images, writings, recordings, media, facts, representations and references; and prior, current and potential transactions which may be comprised in profiles of entrants, collectively referred to as entrant data profiles. Entrant data profiles may comprise data extracted or received from sources of entrant data such as, but not limited to, social media, third party authorities, direct feedback regarding prior transactional relationships, crowd-sourced rating systems and the entrant. With respect to the risk/reward scoring system, such sources of entrant data may be local or remote, or a combination thereof. A risk/reward scoring system may further comprise a traits extractor which may extract from an entrant data profile a plurality of traits, also referred to as entrant traits, which may represent distinguishing characteristics or qualities which may provide a behavioral representation of the entrant. A risk/reward scoring system may further comprise a factors extractor which may extract from an entrant data profile a plurality of factors, also referred to as entrant factors, which may comprise situational factors and historical factors, such as those that may relate to situational and historical events, aspects, facts, representations and references, each of which may relate to an entrant, a potential transaction or an entrant and a previous, current or potential transaction. A risk/reward scoring system may further comprise an outcomes extractor which may extract from an entrant data profile a plurality of outcomes, also referred to as entrant outcomes, which may comprise results such as those relating to previous transactional relationships, activities, events and actions of an entrant. Entrant traits, entrant factors and entrant outcomes for an entrant may be collectively referred to as an entrant feature profile. Entrant outcomes may additionally relate to and serve as entrant factors.

A risk/reward scoring system may further comprise a risk/reward model which may comprise a modeled relationship between entrant traits and factors as inputs, and entrant outcomes as outputs, modeled over a plurality of entrant feature profiles, thereby establishing a statistical, probabilistic and predictive relationship between entrant traits and entrant factors as inputs, and entrant outcomes as outputs. When provided entrant traits and entrant factors as inputs, the risk/reward model produces a set of outcomes as outputs which represent evaluative considerations and measures and may comprise statistical, probabilistic and predictive outcomes.

A risk/reward scoring system may comprise a risk/reward modeler which comprises model training and testing entrant traits and factors as inputs and model training and testing entrant outcomes as target variables, and models a relationship between these inputs and target output variables. A risk/reward scoring system may be implemented to provide risk/reward scores for a single type of transaction or application. Alternatively, a risk/reward scoring system may be implemented to provide risk/reward scores for a plurality of types of transactions and applications. Such a risk/reward modeler may select and model entrant traits and factors as inputs and entrant outcomes as outputs for a given application, for example, for an electric bike rental application, and as such, model an electric bike rental application-specific risk/reward model. By using selective application-specific modeling, such a modeler can generate a plurality of application-specific risk/reward models for a plurality of applications. As prefaced briefly before, entrant outcomes may additionally be copied to, applied to or otherwise factored into entrant factors wherein such entrant factors are effective in modeling and scoring outcomes. For example, a pattern of repeatedly returning electric bike rentals with damage is a strong predictor of future damage and can therefore also be included in entrant factors for modeling and future risk/reward scoring of a transactional relationship with an entrant.

A risk/reward scoring system may alternatively comprise a two-tier modeling and scoring architecture which has a platform predictive intelligence modeler which can select and model all entrant traits and factors as inputs and all entrant outcomes as outputs, agnostic of application, and generate a platform predictive intelligence model. In such a risk/reward scoring system, the statistical, probabilistic and predictive intelligence comprised in a majority or all of the entrant feature profiles, encompassing a plurality of applications and comprised in a risk/reward scoring system may be combined to represent an increased level of statistical, probabilistic and predictive intelligence in a single modeled relationship. A platform predictive intelligence model can be used in such a two-tier modeling and scoring architecture, wherein application-specific models can be modeled using the output of the platform predictive intelligence model, also referred to as a platform predictive intelligence entrant vector, as inputs for modeling an application-specific risk/reward model comprising a modeled relationship between platform predictive intelligence entrant vectors as inputs and application-specific entrant outcomes as outputs. In such a two-tier model system, when provided entrant traits and entrant factors as inputs to the platform predictive intelligence model, a platform predictive intelligence entrant vector is generated as output and then can be used as an input to an application-specific risk/reward model, which then in turn produces a set of outcomes as outputs which represent evaluative considerations and measures and may comprise statistical, probabilistic and predictive outcomes. This two-tier modeling architecture allows the overall system predictive intelligence to benefit from platform wide predictive modeling, yet be adapted for risk/reward scoring within a specific application.

A risk/reward scoring system may comprise a universal modeler which can model a platform predictive intelligence model and one or more application-specific risk/reward models. In such an embodiment, the universal modeler first generates a platform predictive intelligence model, and using the generated platform predictive intelligence model in a two-tier modeling architecture, further generates one or more application-specific risk/reward models.

A risk/reward scoring system may comprise application-specific scoring profiles related to specific applications and may be further related to specific evaluating entities, which may be also referred to as subscribers. A risk/reward scoring system may comprise anonymity profiles which may be related to entrants, specific applications and subscribers. To generate a risk/reward score for an application-specific transaction in view of transactional relationship with an entrant, a risk/reward scoring system can use an associated anonymity profile to govern usage and disclosure of entrant data for the indicated entrant, application and subscriber, select an indicated application-specific risk/reward model and use an associated application-specific profile to generate and format the risk/reward score as indicated for the application and subscriber.

A typical process flow for risk/reward scoring in transactional relationships may begin with the receipt of a risk/reward score request by a risk/reward scoring system. A risk/reward score request would typically comprise a transactional entity identifier (entrant ID or information from which an entrant ID may be created), an evaluating entity identifier (subscriber ID), an implied or specified application identifier (application ID), and may additionally comprise supplied data related to one or more of the entrant, the subscriber and the application-specific transaction. The risk/reward scoring system would then check to see if an entrant ID exists for the transactional entity. If an entrant ID is not located, then the risk/reward scoring system would generate a new entrant ID, anonymity profile and using the anonymity profile to govern entrant data usage and disclosure would generate an entrant data profile. If an entrant ID is located, then the risk/reward scoring system would update the corresponding anonymity profile and using the anonymity profile to govern entrant data usage and disclosure would update the entrant data profile as indicated. Pertinent anonymity rules needed by future components and processes of the risk/reward system, such as entrant feature extraction, risk/reward scoring, score formatting and score response, can either be propagated through the system and reside in entrant data profiles, entrant feature profiles, application profiles and formatting rules databases or such anonymity rules can be accessed directly from anonymity profiles as needed. Next, the risk/reward scoring system generates entrant traits, entrant factors and entrant outcomes and builds an entrant feature profile. Depending on the embodiment of the risk/reward scoring system, the risk/reward scoring system then generates a risk/reward score based on the entrant feature profile, and which score may be application-specific, or first generates an platform predictive intelligence entrant vector based on the entrant feature profile, and then generates an application-specific risk/reward score based on the platform predictive intelligence entrant vector. The resulting risk/reward score can then be formatted as indicated by the application profile, wherein the format may be specified in part by the subscriber submitting the score request. The formatted risk/reward score is then sent in response to the risk/reward score request.

To maintain data reflecting an ongoing passage of time, an entrant data manager may periodically age entrant data profiles and other entrant data, and may indicate some or all of the aged entrant data is not to be further used in some or all entrant feature extraction, modeling and scoring processes, or otherwise delete or discard such some or all aged entrant data. Data changes, indications and deletions related to entrant data aging, may be further reflected in entrant feature profiles by entrant feature extractors, and platform and/or application models by modelers, and in turn be reflected in the risk/reward scores produced thereby.

Entrant data aging may further comprise creating or updating age indicators associated with entrant data fields, indicating an age or time duration of the data, such as a time duration since recording, acquisition and/or event related to such recording or acquisition, or the data itself. Entrant data aging may further comprise determining an impact indicator, which may be a numeric indicator, which may indicate a level of relevance, significance or weighting associated with the entrant data, wherein such impact indication is determined at least in part due to an age or time duration associated with the entrant data.

Entrant data aging may further comprise a process which generates derivative entrant data associated with entrant data or entrant features due to an age and/or time duration of at least some of the entrant data or entrant features used to generate such derivative entrant data, and may then indicate that some of the so such used entrant data is not to be further used and may be deleted. Derivative entrant data may supplant and make obsolete one or more entrant data fields within an entrant data profile and comprise an age indicator associated with an age or time duration associated with the data field, wherein such age or time duration is a determination of a time duration since recording, acquisition and/or event related to such recording or acquisition, of at least some of the entrant data or entrant features used to generate associated derivative entrant data. Derivative entrant data may further comprise one or more impact indicators, which may be a numeric indicator, which may indicate a level of relevance, significance or weighting associated with the derivative entrant data, wherein such impact indication is determined at least in part due to an age or time duration associated with the derivative entrant data.

Changes to entrant data resulting from and relating to entrant data aging, such as aged entrant data, derivative entrant data, supplanted entrant data fields, obsoleted entrant data fields, newly created or modified indicators, and entrant data deletions, may be further reflected in entrant feature profiles by entrant feature extractors, and platform and/or application models by modelers, and in turn be reflected in the risk/reward scores produced thereby.

### BRIEF DESCRIPTION OF THE SEVERAL VIEWS OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of the disclosed subject matter.

FIG. 1A is an exemplary embodiment of a risk/reward scoring system.

FIG. 1B is an exemplary system diagram depicting the risk/reward scoring system of FIG. 1A in a system environment.

FIG. 1C is a block diagram of an example embodiment of a subscriber application services system of the risk/reward system environment of FIG. 1B.

FIG. 1D is a block diagram of an example embodiment of a smartphone device of the risk/reward system environment of FIG. 1B.

FIG. 1E is a diagram of example components of a device comprised by or usable with the risk/reward scoring system of FIG. 1A, or risk/reward system environment of FIG. 1B.

FIG. 1E is a diagram of example components of a device comprised by or usable with the risk/reward scoring system 100 of FIG. 1A.

FIG. 2 is an exemplary embodiment of an entrant data profiles table.

FIG. 3 is an exemplary embodiment of an entrant feature profiles table.

FIG. 4A is an exemplary flow diagram of a response process for a risk/reward score request.

FIG. 4B is an exemplary flow diagram for a risk/reward model creation or update process.

FIG. 5a is an exemplary embodiment of a risk/reward score.

FIG. 5b is an exemplary embodiment of a “Yes/No” risk/reward score.

FIG. 6 is an exemplary embodiment of a risk/reward scoring system supporting a plurality of types of application-specific risk/reward scoring models.

FIG. 7 is an exemplary embodiment of an application profiles table.

FIG. 8 is an exemplary embodiment of an anonymity profiles table.

FIG. 9a is an exemplary flow diagram of a response process for a risk/reward score request for the risk/reward scoring system of FIG. 6.

FIG. 9b is an exemplary flow diagram for a risk/reward model creation or update process for the risk/reward scoring system of FIG. 6.

FIG. 10A is an exemplary embodiment of a risk/reward scoring system comprising a two-tier model architecture supporting a plurality of types of application-specific risk/reward scoring models in an applications tier and utilizing a platform predictive intelligence model in a platform tier.

FIG. 10B is an exemplary embodiment of a universal model builder of a universal modeler of the risk/reward scoring system of FIG. 10A.

FIG. 11 is an exemplary view of portions of the risk/reward scoring system of FIG. 10A which illustrates a two-tier modeling architecture thereof, and comprises platform predictive intelligence vectors.

FIG. 12A is an exemplary flow diagram of a response process for a risk/reward score request for the risk/reward scoring system of FIG. 10A.

FIG. 12B is an exemplary flow diagram for a platform predictive intelligence model creation or update process for the risk/reward scoring system of FIG. 10A.

FIG. 12C is an exemplary flow diagram for an application-specific risk/reward model creation or update process for the risk/reward scoring system of FIG. 10A.

### DETAILED DESCRIPTION

Various detailed example embodiments of risk/reward scoring systems and various embodiments of methods for risk/reward scoring in transactional relationships are disclosed herein; however, it is to be understood that the disclosed embodiments are merely illustrative and may be embodied in various forms. In addition, each of the examples given in connection with the various embodiments is intended to be illustrative, and not restrictive.

The following detailed example embodiments refer to the accompanying drawings. The same reference number may appear in multiple drawings and when appearing in multiple drawings will identify the same or similar elements.

Systems and methods for risk/reward scoring in transactional relationships are disclosed. These systems and methods can be referred to as risk/reward scoring systems. Risk/reward scoring systems support evaluative consideration of the merits of a transaction in view of a transactional entity, and provide a risk/reward score which may comprise statistical, probabilistic and predictive evaluative measures. Risk/reward scoring systems may provide a risk/reward score for a potential transaction in view of a transactional entity that spans a plurality of evaluative considerations, and score evaluative measures within such evaluative considerations, which may comprise statistical, probabilistic and predictive indicators, thereby providing information needed to more fully evaluate a potential transaction, and do so in view of a transactional relationship with a transactional entity.

A risk/reward score may comprise a plurality of scores of various evaluative considerations and/or evaluative measures, some of which may be statistical, probabilistic or predictive in nature, such that an evaluating entity in possession of a risk/reward score, can make a more fully informed determination to proceed with a potential transaction, how to proceed with the transaction or reject the transaction. A risk/reward score can be provided in varying formats and levels of detail to serve varying levels of automation, details of policy and procedure and levels of review and decision making. A risk/reward score may comprise a summary score based on a plurality of evaluative considerations and/or evaluative measures which may comprise statistical, probabilistic and predictive indications, which may be applied to a predetermined threshold in order to make a simple or automated determination to proceed with a potential transaction, how to proceed with the transaction or reject the transaction. A risk/reward score may comprise a plurality of scores regarding a plurality of evaluative considerations and/or evaluative measures which may comprise statistical, probabilistic and predictive indicators, wherein one or more scores may be applied to corresponding predetermined thresholds in order to make a simple or automated determination to proceed with a potential transaction, how to proceed with the transaction or reject the transaction. A risk/reward score may comprise a plurality of scores regarding a plurality of evaluative considerations and/or evaluative measures which may comprise statistical, probabilistic and predictive indicators, wherein one or more scores may be a composite score of a plurality of scores, and may be applied to corresponding predetermined thresholds in order to make a simple or automated determination to proceed with a potential transaction, how to proceed with the transaction or reject the transaction, or alternatively be reviewed for a more complete understanding of the scores in order to make a determination to proceed with a potential transaction, how to proceed with the transaction or reject the transaction.

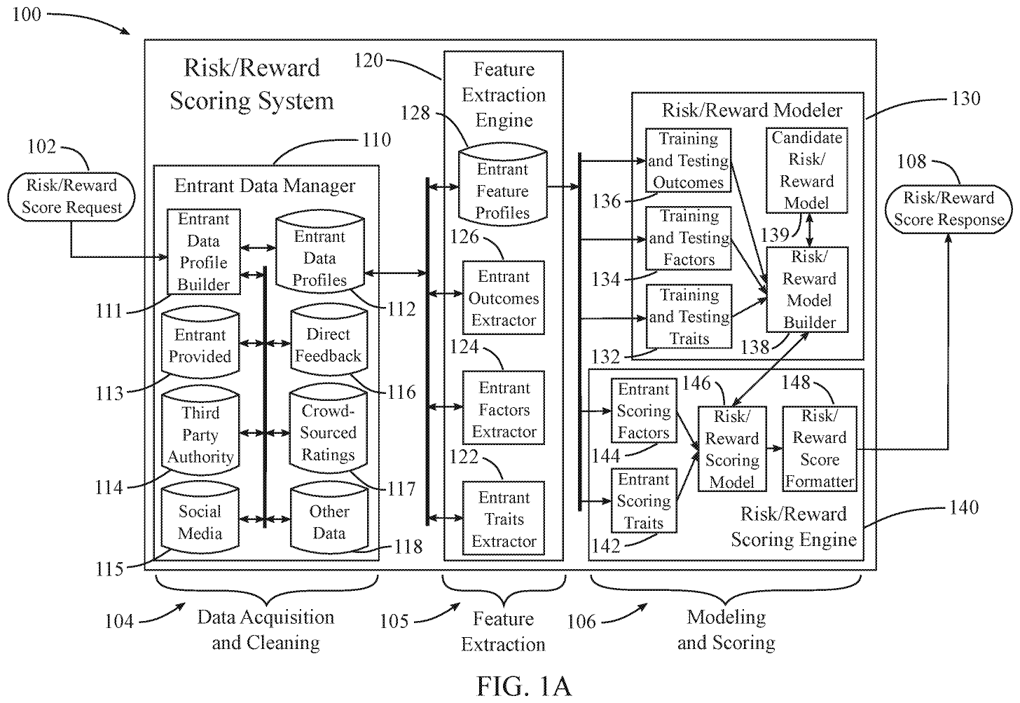

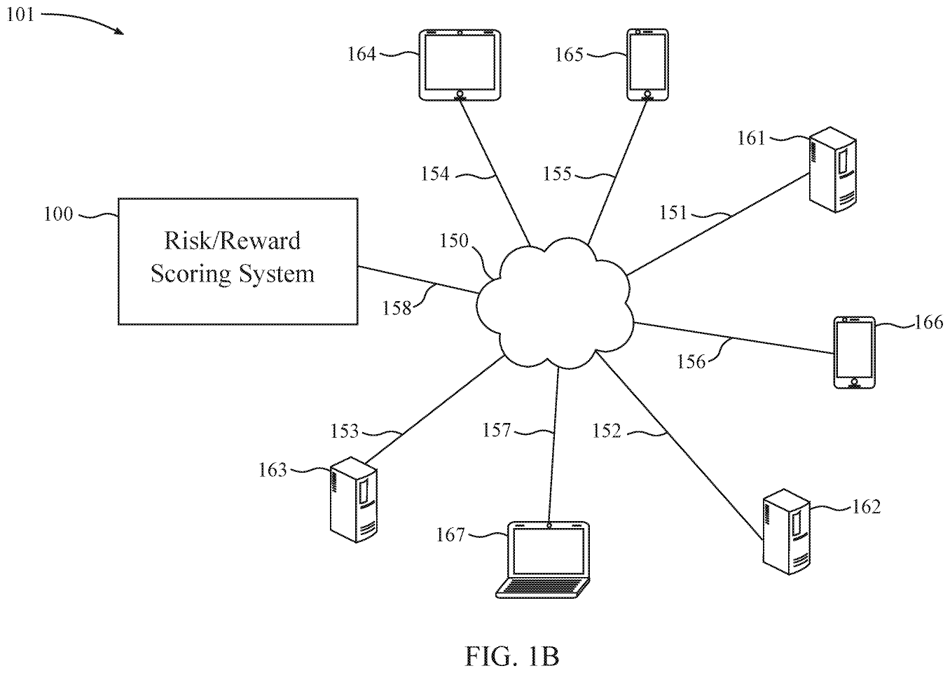

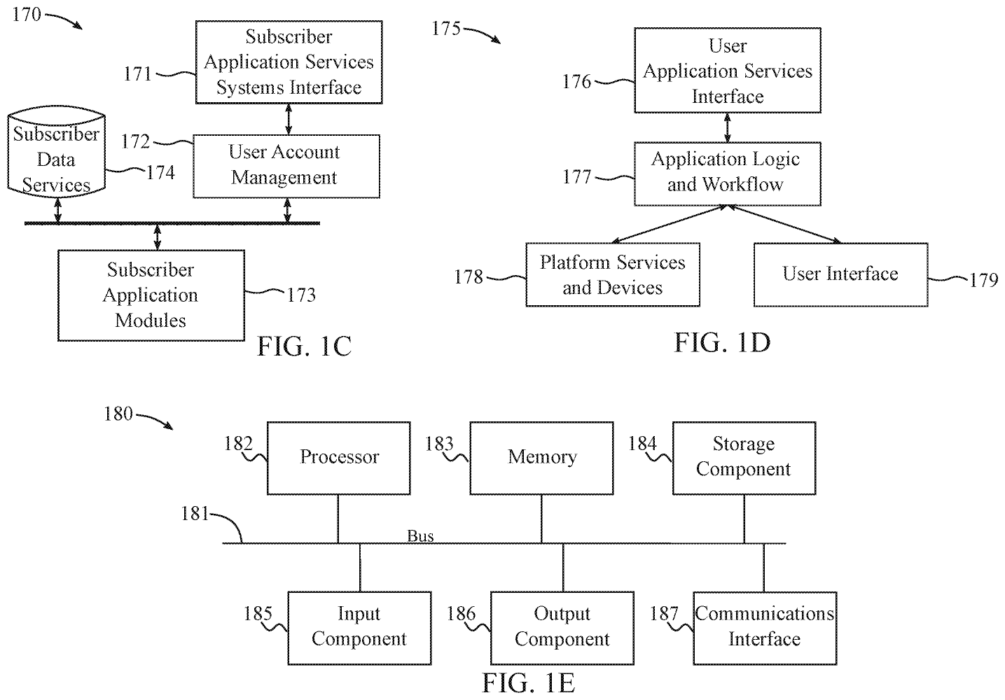

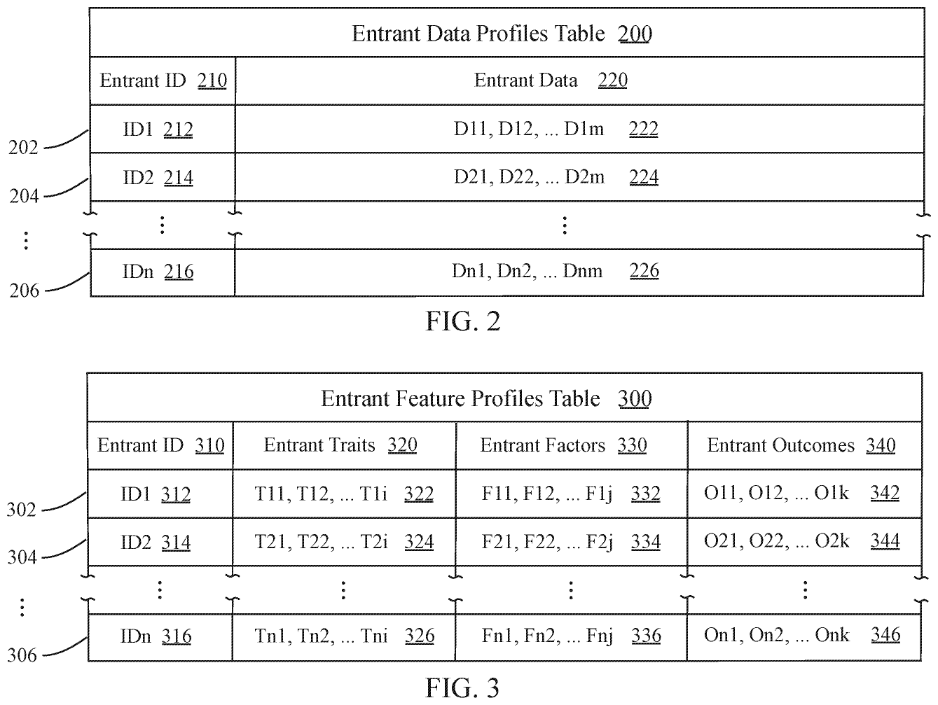

Referring to FIG. 1A, an exemplary embodiment of a risk/reward scoring system 100 is shown. Risk/reward scoring system 100 comprises an entrant data manager 110, a feature extraction engine 120, a risk/reward modeler 130 and a risk/reward scoring engine 140. Entrant data manager 110 comprises an entrant data profile builder 111, entrant data profiles database 112 associated with a plurality of entrants, and exemplary sources of entrant data 113-118, where such data may originate from a plurality of sources of varying types and names, be organized in many various ways, and some or all may not reside within the risk/reward scoring system 100, and be accessed remotely therefrom. For exemplary and illustrative purposes, entrant data manager 110 is depicted in FIG. 1A having sources of entrant data 113-118 local to risk/reward scoring system 100 and organized by exemplary, common or general names relating to sources of such data. Such sources of entrant data 113-118 may comprise entrant provided data 113, third party authority data 114, social media data 115, direct feedback data 116, crowd-sourced ratings data 117 and other data 118. Each entrant can have associated therewith data from some or all sources of entrant data 113-118, which can be accessed by entrant data profile builder 111 to create an entrant data profile record, such as those depicted in FIG. 2, associated with the entrant, which may be stored in entrant data profiles database 112.

A risk/reward system 100 may reside in a risk/reward system environment wherein one or more subscriber systems may be configured to communicate therewith and one or more user devices, such as a device of an entrant or transactional entity, may be configured to communicate therewith. FIG. 1B is an exemplary system diagram depicting risk/reward scoring system 100 in a risk/reward system environment 101, wherein example risk/reward system environment 101 may comprise risk/reward system 100, subscriber systems 161, 162 and 163 and user devices 164, 165, 166 and 167, all of which may be connected to network 150 via communications links 151, 152, 153, 154, 155, 156, 157 and 158 as shown in FIG. 1B. Subscriber systems 161, 162 and 163 may be server based systems comprising one or more servers, software and data services comprising one or more databases, and may be cloud-based systems. User devices 164, 165, 166 and 167 are shown in FIG. 1B as illustrative examples as a tablet 164, smartphones 165 and 166 and computer 167. Subscriber systems and user devices may be configured with application services and applications such that user devices 164, 165, 166 and 167 may interact with one or more subscriber systems 161, 162 and 163 /and or risk/reward scoring system 100 over communications network 150 and communications links 151, 152, 153, 154, 155, 156, 157 and 158.

FIG. 1C is a block diagram of an example embodiment of a subscriber application services system 170 of subscriber systems 161, 162 and 163 of risk/reward system environment 101. In some implementations, subscriber application services system 170 may comprise a subscriber application services systems interface 171, such as an application programming interface (API) or application services interface module, subscriber data services 174, a user account management module 172 and subscriber application modules 173.

FIG. 1D is a block diagram 175 of an example embodiment of a user device such as a tablet 164, smartphone 165 or 166 or computer 167 of risk/reward system environment 101. In some implementations, user devices 164, 165, 166 and 167 may comprise a user application services interface 176, application logic and workflow 177, platform services and devices 178 and a user interface 179. FIG. 1C depicts one of many possible ways to organize and represent interfaces, software, services and devices that may reside on a user device such as user devices 164, 165, 166 and 167. Also referring to FIG. 1B and FIG. 1C, application logic and workflow 177 may provide for management and control of user interaction with a user device 164, 165, 166 or 167 and a user account comprised by a subscriber system 161, 162 and/or 163, and/or risk/reward scoring system 100 or risk/reward scoring environment 101.

FIG. 1E is a diagram of example components of a device 180 comprised by or usable with the risk/reward scoring system 100 of FIG. 1A or risk/reward system environment 101 of FIG. 1B, such as devices comprised by subscriber systems 161, 162 or 163, or user devices 164, 165, 166 or 167, as discussed above which enable users and subscribers to interact with risk/reward scoring system 100. Device 180 may correspond to one or more devices comprised by risk/reward system 100, such as one or more servers thereof and may correspond to one or more devices comprised by a cloud-based system potentially comprising risk/reward system 100 and potentially risk/reward system 100 in part. In some implementations, risk/reward system 100, subscriber systems 161, 162 and 163, and user devices 164, 165, 166 and 167 may include one or more devices 180 and/or one or more components of device 180.

Bus 181 includes a component that permits communication among the components of device 180. Processor 182 may be implemented in hardware, firmware, or a combination of hardware and firmware. Processor 182 includes a processor (e.g., a central processing unit (CPU), a graphics processing unit (GPU), and/or an accelerated processing unit (APU)), a microprocessor, a microcontroller, and/or any processing component (e.g., a field-programmable gate array (FPGA) and/or an application-specific integrated circuit (ASIC)) that interprets and/or executes instructions. In some implementations, processor 182 includes one or more processors capable of being programmed to perform a function. Memory 183 includes a random access memory (RAM), a read only memory (ROM), and/or another type of dynamic or static storage device (e.g., a flash memory, a magnetic memory, and/or an optical memory) that stores information and/or instructions for use by processor 182.

Storage component 184 stores information and/or software related to the operation and use of device 180. For example, storage component 184 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 185 includes a component that permits device 180 to receive information, such as via user input (e.g., a touch screen display, a keyboard, a keypad, a mouse, a button, a switch, and/or a microphone). Additionally, or alternatively, input component 185 may include a sensor for sensing information (e.g., a global positioning system (GPS) component, an accelerometer, a gyroscope, and/or an actuator). Output component 186 includes a component that provides output information from device 180 (e.g., a display, a speaker, and/or one or more light-emitting diodes (LEDs)).

Communication interface 187 includes a transceiver-like component (e.g., a transceiver and/or a separate receiver and transmitter) that enables device 180 to communicate with other devices, such as via a wired connection, a wireless connection, or a combination of wired and wireless connections. Communication interface 187 may permit device 180 to receive information from another device and/or provide information to another device. For example, communication interface 187 may include an Ethernet interface, an optical interface, a coaxial interface, an infrared interface, a radio frequency (RF) interface, a universal serial bus (USB) interface, a Wi-Fi interface, a cellular network interface, or the like.

Device 180 may perform one or more processes described herein. Device 180 may perform these processes in response to processor 182 executing software instructions stored by a non-transitory computer-readable medium, such as memory 183 and/or storage component 184. A computer-readable medium is defined herein as a non-transitory memory device. A memory device includes memory space within a single physical storage device or memory space spread across multiple physical storage devices. In some implementations, a memory device may be cloud-based, partially cloud-based, or not cloud-based.

Software instructions may be read into memory 183 and/or storage component 184 from another computer-readable medium or from another device via communication interface 187. When executed, software instructions stored in memory 183 and/or storage component 184 may cause processor 182 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 1D are provided as an example. In practice, device 180 may include additional components, fewer components, different components, or differently arranged components than those shown in FIG. 1D. Additionally, or alternatively, a set of components (e.g., one or more components) of device 180 may perform one or more functions described as being performed by another set of components of device 180.

FIG. 2 depicts an exemplary entrant data profiles table 200, comprising 1, 2, . . . n entrant data profile records 202, 204, . . . 206, respectively. Entrant data profile records 202, 204, . . . 206 comprise an entrant ID in entrant ID column 210, namely ID1 212, ID2 214, . . . IDn 216, respectively, and further comprise entrant data fields in entrant data column 220, namely D11, D12, . . . D1m 222, D21, D22, . . . , D2m 224, . . . Dn1, Dn2, . . . , Dnm 226, respectively.

Returning to FIG. 1A, feature extraction engine 120 comprises an entrant traits extractor 122, an entrant factors extractor 124, an entrant outcomes extractor 126 and entrant feature profiles database 128. Turning to FIG. 3 in conjunction with FIG. 1A, FIG. 3 depicts an exemplary entrant feature profiles table 300. Entrant traits extractor 122 accesses entrant data profiles database 112 to extract features associated with entrant traits for inclusion in an entrant feature profiles table 300. Alternatively, entrant traits extractor 122 could access a third party service, not shown in FIG. 1A, such as that currently provided by IBM Personality Insights, a service provided by International Business Machines Corp., New Orchard Road, Armonk, N.Y., 10504, which can extract traits from data, such as traits associated with five primary personality characteristics, wherein each characteristic has six facets. In the exemplary table shown in FIG. 3, entrant feature profiles table 300 comprises 1, 2, . . . n entrant feature profile records 302, 304, . . . 306, respectively. Entrant feature profile records 302, 304, . . . 306 comprise an entrant ID in entrant ID column 310, namely ID1 312, ID2 314, . . . IDn 316, respectively, and further comprise entrant traits in entrant traits column 320, which comprises entrant traits fields for entrant feature profile records 302, 304 and 306, namely, T11, T12, . . . T1i 322, T21, T22, . . . T2i 324, . . . Tn1, Tn2, . . . , Tni 326, respectively, wherein entrant traits extractor 122 can store extracted entrant traits. Extracted entrant traits can be a plurality of traits which may provide a behavioral representation of the entrant and comprise one or more indicators which may be numeric. Entrant traits may further comprise an indication related to a confidence level of one or more indicators.

Entrant factors extractor 124 accesses entrant data profiles database 112 to extract features associated with entrant factors, such as those relating to situational and historical events, aspects, facts, representations and references each of which may relate to an entrant, a potential transaction or an entrant and a previous, current or potential transaction, for inclusion in an entrant feature profiles table 300. Entrant feature profile records 302, 304, . . . 306 comprise entrant factors in entrant factors column 330, which comprises entrant factors fields for entrant feature profile records 302, 304 and 306, namely, F11, F12,. . . F1j 332, F21, F22, . . . F2j 334, . . . Fn1, Fn2, . . . , Fnj 336, respectively, wherein entrant factors extractor 124 can store extracted entrant factors. Extracted entrant factors may provide a situational and historical representation of the entrant and include aspects of prior, current or potential transactions, and be a plurality of factors which may comprise one or more indicators which may be numeric. Entrant factors may further comprise an indication related to a confidence level of one or more indicators.

Entrant outcomes extractor 126 accesses entrant data profiles database 112 to extract features associated with entrant outcomes such as results relating to previous transactional relationships, activities, events and actions of an entrant for inclusion in an entrant feature profiles table 300. Entrant feature profile records 302, 304, . . . 306 comprise entrant outcomes in entrant outcomes column 340, which comprises entrant outcomes fields for entrant feature profile records 302, 304 and 306, namely, O11, O12, . . . O1k 342, O21, O22, . . . O2k 344, . . . On1, On2, . . . , Onk 346, respectively, wherein entrant outcomes extractor 126 can store extracted entrant outcomes. Extracted entrant outcomes may be a plurality of outcomes relating to prior activities of the entrant and may comprise one or more indicators which may be numeric. Entrant outcomes may further comprise an indication related to a confidence level of one or more indicators. Entrant outcomes may additionally be copied to, applied to or otherwise included in entrant factors wherein such entrant factors are effective in modeling and scoring outcomes.

Risk/reward scoring engine 140 comprises entrant scoring traits 142, entrant scoring factors 144, risk/reward scoring model 146 and a risk/reward score formatter 148. To generate a risk/reward score related to an entrant, risk/reward scoring engine 120 can retrieve a set of corresponding entrant traits for scoring, also referred to as entrant scoring traits 142 and entrant factors for scoring, also referred to as entrant scoring factors 144, which collectively represent an entrant for scoring, from entrant feature profiles database 128. Risk/reward scoring model 146 can then determine, and risk/reward score formatter can format, a risk/reward score for a potential transaction in view of a transactional relationship with the entrant which may comprise a plurality of scores of various evaluative considerations and/or evaluative measures, some of which may be statistical, probabilistic or predictive in nature and comprise measures of potential outcomes.

Risk/reward modeler 130 comprises training and testing traits 132, training and testing factors 134, training and testing outcomes 136, a risk/reward model builder 138 and a candidate risk/reward model 139. Risk/reward model builder 138 can use machine learning to train and test a candidate risk/reward model 139 to serve as a newly created or updated risk/reward scoring model 146. Risk/reward modeler 130 and risk/reward model builder 138 may access entrant feature profiles database 128 to retrieve entrant feature profiles to train and test a candidate risk/reward model 139. When so used, such entrant feature profiles can be referred to as training and testing feature profiles comprising training and testing traits 132, training and testing factors 134 and training and testing outcomes 136. Risk/reward model builder 138 may use training and testing traits 132 and training and testing factors 134 as input values and use training and testing outcomes 136 as target variables for modeling a relationship between these input values and target variables. To deploy a newly created or updated risk/reward model, risk/reward model builder 138 can deploy a completed candidate risk/reward model 139 to risk/reward scoring model 146.

Where a market preference for a known or traditional scoring algorithm and resulting preferred known or traditional score, such as a FICO score for example, is established, an embodiment may be implemented wherein entrant data manager 110 sources such a known or traditional score from a known or traditional source. Alternatively, an embodiment may be implemented wherein feature extractor 120 can calculate a known, traditional or similar score using the same or a similar algorithm to that commonly used to calculate the known or traditional score. This same or similar, known or traditional score may then be used as an entrant factor, comprised in entrant feature profiles database 128, for use as an entrant scoring factor 144, and be mapped, directly or indirectly, by the risk/reward scoring model 146 to an evaluative consideration or evaluative measure as a score, or a component thereof within a risk/reward score, and additionally be used as an entrant training and testing factor 134 by risk/reward modeler 130 and risk/reward model builder 138 to model its relationship to evaluative considerations and evaluative measures. As such, this same or similar, known or traditional score may then be used as an entrant scoring factor 144 for both scoring evaluative considerations and evaluative measures, and be additionally mapped, directly or indirectly, to an evaluative consideration and evaluative measure within a risk/reward score 148.

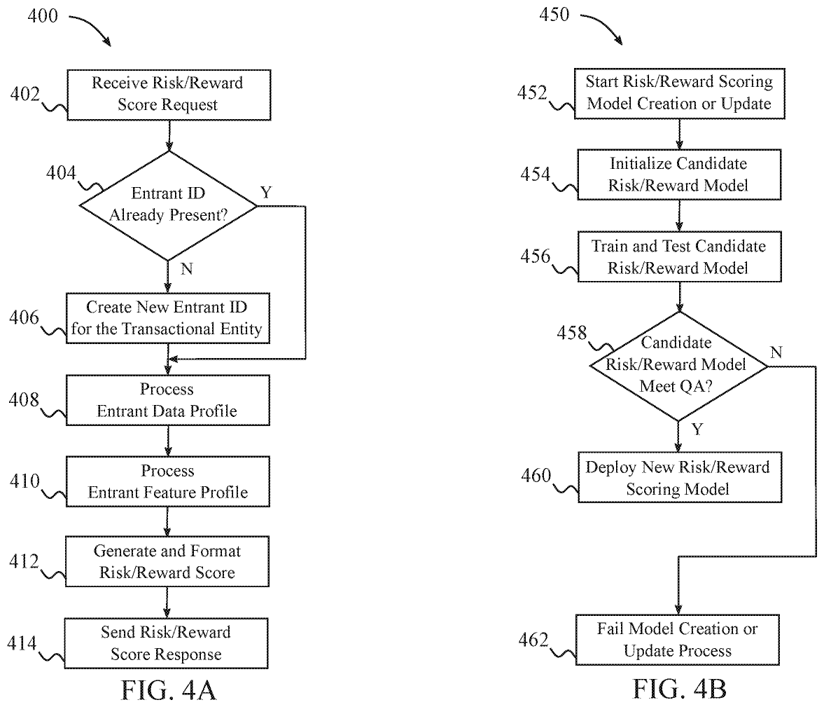

The major functions of risk/reward scoring system 100 can be grouped into three primary sections of functions, namely, a data acquisition and cleaning section 104 which comprises entrant data manager 110, a feature extraction section 105 which comprises feature extraction engine 120, and a modeling and scoring 106 section which comprises risk/reward modeler 130 and risk/reward scoring engine 140. FIG. 4A depicts an exemplary flow diagram 400 of the processing of a risk/reward score request 102. Referring to FIG. 4A in addition to FIG. 1A, when a risk/reward score request 102 to score a transactional entity is received in step 402 by risk/reward scoring system 100, entrant data profile builder 111 of entrant data manager 110 of data acquisition and cleaning section 104 checks to see in step 404 if the transactional entity to be scored is already an entrant in the risk/reward scoring system 100 as evidenced by the presence of an associated entrant ID and entrant data profile in the entrant data profiles database 112. If one is present, processing of the risk/reward score request proceeds to step 408, otherwise entrant data profile builder 111 creates a new entrant ID for the transactional entity in step 406, upon which the transactional entity becomes an entrant. In step 408, an entrant data profile record in entrant data profile table 200 of FIG. 2 comprised in entrant data profiles database 112 is then processed. Next in step 410, feature extraction engine 120 of feature extraction section 105 processes an entrant feature profile record in entrant feature profile table 300 of FIG. 3 comprised in entrant feature profiles database 128. In step 412, risk/reward scoring engine 140 of modeling and scoring section 106 selects entrant scoring traits 142 and entrant scoring factors 144 from entrant feature profile table 300 in entrant feature profiles database 128, whereupon risk/reward scoring model 146 generates, and risk/reward score formatter 148 formats, a risk/reward score which may comprise a plurality of scores of various evaluative considerations and/or evaluative measures, some of which may be statistical, probabilistic or predictive in nature and comprise measures of potential outcomes for a potential transaction in view of a transactional relationship with the entrant (transactional entity). Lastly, in step 414, risk/reward scoring engine 140 sends a risk/reward score response 108.

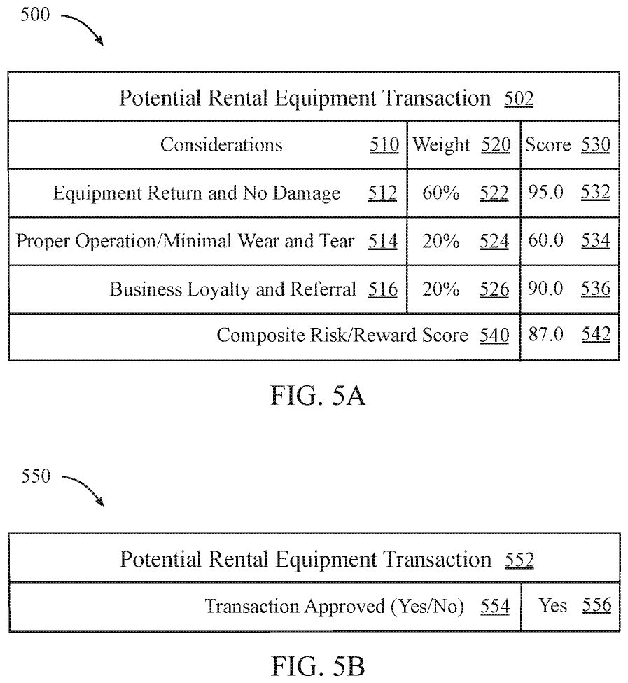

FIG. 5a depicts an exemplary risk reward score 500 for a “Potential Rental Equipment Transaction” 502, having a “Considerations” column 510, a score “Weight” 520 column and a “Score” column 530. “Considerations” column 510, which may comprise evaluative considerations and evaluative measure, comprises “Equipment Return and No Damage” 512, “Proper Operation/Minimal Wear and Tear” 514 and “Business Loyalty and Referral” 516 having score weights 520 of “60%” 522, “20%” 524 and “20%” 526, respectively, and scores 530 of “95.0” 532, “60.0” 534 and “90.0” 536, respectively, which are exemplary numeric indicators indicating a probability of outcome of a corresponding evaluative consideration or evaluative measure and comprised therein. Such numeric indicators indicating a probability can be normalized to a percentage scale, or other scale, and further be adjusted and formatted during a formatting process for ease of understanding when presented to a subscriber or other recipient of the score. Weights 520, 522 and 524 may additionally be numeric indicators representing the relative significance of a corresponding evaluative consideration or evaluative measure and may be used to generate a summary or composite risk/reward score such as depicted in FIG. 5a 542. Numeric indicator weights 522, 524 and 526 may be comprised by corresponding evaluative considerations or evaluative measures, however, depending on the embodiment of the risk/score scoring system, such numeric indicators of weights may be comprised by risk/reward scoring engine 140 and applied during the risk/reward score generation and formatting process step 412 of FIG. 4. Risk/reward score 500 for “Potential Rental Equipment Transaction” 502 has a “Composite Risk/Reward Score” 540 of “87.0” 542, which is the sum of the individual scores 532, 534 and 536 scores multiplied by their associated weights 522, 524 and 526, respectively. While no explicit score is present for evaluative considerations of legitimacy, intention, capacity, creditworthiness or trustworthiness, these and other evaluative considerations and/or evaluative measures may be comprised as components of the scores present in order to provide a simple risk/reward score upon which it is easy to establish policies and procedures. Furthermore, scores for some evaluative considerations and/or evaluative measures may not be explicitly presented in order to protect sensitive information about a transactional entity, or not communicate information which may otherwise contribute to an awkward, confrontational or otherwise deleterious relationship between the evaluating entity (subscriber) and transactional entity (entrant). In some applications and for some subscribers in some applications, a “Yes” or “No” score may be employed as it relates to whether to proceed with or reject a potential transaction in view of a transactional relationship with a transactional entity. FIG. 5b depicts an exemplary yes/no risk/reward score 550 for a “Potential Rental Equipment Transaction” 552, having a “Transaction Approved (Yes/No)” 554 score of “Yes” 556.

FIG. 4B depicts an exemplary flow diagram of a process 450 to create or update risk/reward scoring model 146 of FIG. 1A, also referred to as a modeling process, which may comprise model training, model validation, model cross-validation and model testing. Referring to FIG. 4B and FIG. 1, as additional data is acquired by entrant data manager 110 and stored in entrant data profiles database 112, and further processed by feature extraction engine 120 and stored in entrant feature profiles database 128, modeling process 450 can be initiated periodically such that risk/reward modeler 130 updates risk/reward scoring model 146 periodically. To maintain a model representing, at least in part, entrant data and/or features extracted therefrom currently comprised within the risk/reward scoring system 100, modeling process 450 can be initiated upon at least one of a plurality of events. Such events may comprise, but are not limited to, the acquisition of additional entrant data and/or features extracted therefrom exceeding a predetermined percentage portion of the total entrant data and/or features extracted therefrom within the system, the acquisition of additional entrant data and/or features extracted therefrom exceeding a predetermined amount, the expiration of a predetermined period of time since the last update of the risk/reward scoring model 146, a quality assurance initiated update, newly defined or redefined entrant features, or, newly defined or redefined evaluative considerations or evaluative measures. Alternatively, process 450 can be a continual process, such that the process repeats after completion.

Modeling process 450 begins in step 452 with the start of a risk/reward scoring model creation or update. In step 454, risk/reward model builder 138 initializes candidate risk/reward model 139 for creation or updating and use as a next risk/reward scoring model 146. In step 456, risk/reward model builder 138 trains and tests candidate risk/reward model 139. Such training and testing 456 may comprise model training, model validation, model cross-validation and model testing. Model training and testing 456 of an embodiment of risk/reward scoring system 100 may, in the case of an update to risk/reward scoring model 146, employ incremental learning, wherein recently acquired entrant data and features extracted therefrom not previously used to train risk/reward scoring model 146 is now used to incrementally train and update candidate risk/reward model 139. Alternatively, in another embodiment, risk/reward model builder 138 in model training and testing step 456 may use a comprehensive set of entrant data and features extracted therefrom which may comprise entrant data and features extracted therefrom that was previously used to train and test risk/reward scoring model 146 in addition to entrant data and features extracted therefrom that is newly acquired and not previously used, to train and test candidate risk/reward model 139 for deployment as a new risk/reward scoring model 146. Of course, in the case of a never previously created risk/reward scoring model 146, all entrant data and features extracted therefrom will be new and not previously used with regard to risk/reward scoring model 146. Model training and testing 456 may be an iterative process based on results of testing. Once model training and testing 456 has concluded, step 458 checks if candidate risk/reward model 139 meets quality guidelines. If such quality guidelines are met, then candidate risk/reward model 139 may be deployed as a new risk/reward scoring model 146 in step 460. If candidate risk/reward model 139 does not meet quality guidelines, then the model creation or update process 450 is failed in step 462, and candidate risk/reward model 139 may not be deployed as a new risk/reward scoring model 146.

Risk/reward scoring system 100 of FIG. 1A can be implemented to provide a risk/reward score for a given type of transactional relationship or application. Such a risk/reward score can be referred to as an application-specific risk/reward score. Evaluative considerations and measures and entrant features to be modeled by risk/reward model builder 138 in a risk/reward scoring model 146 and scored in an application-specific risk/reward score can be selected based on their relevance to the given type of transactional relationship or application.

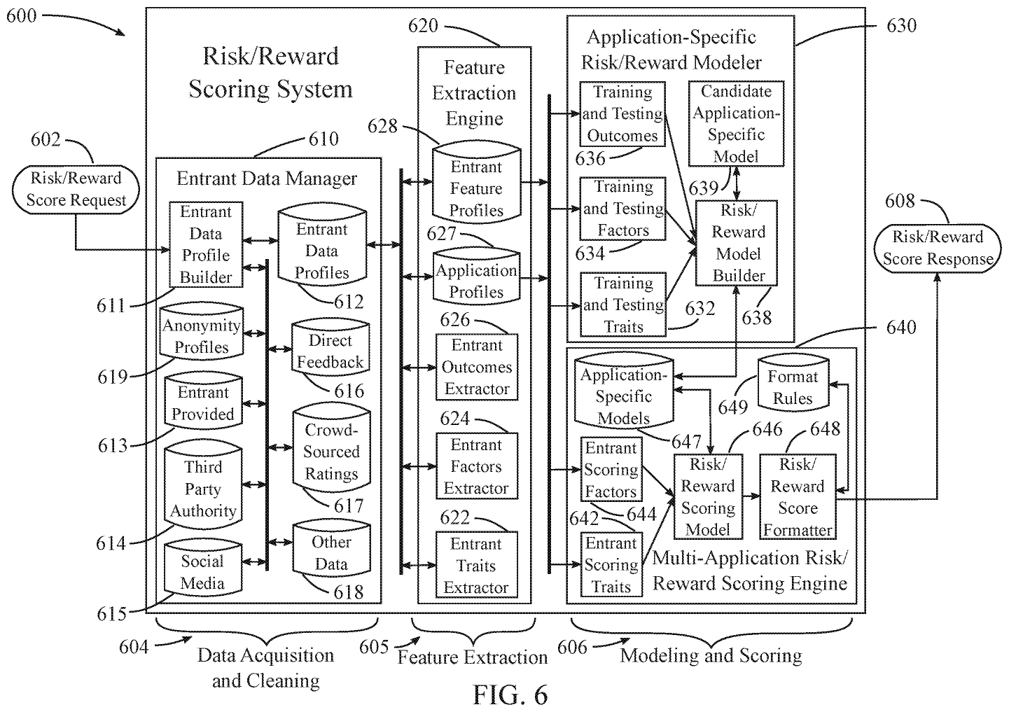

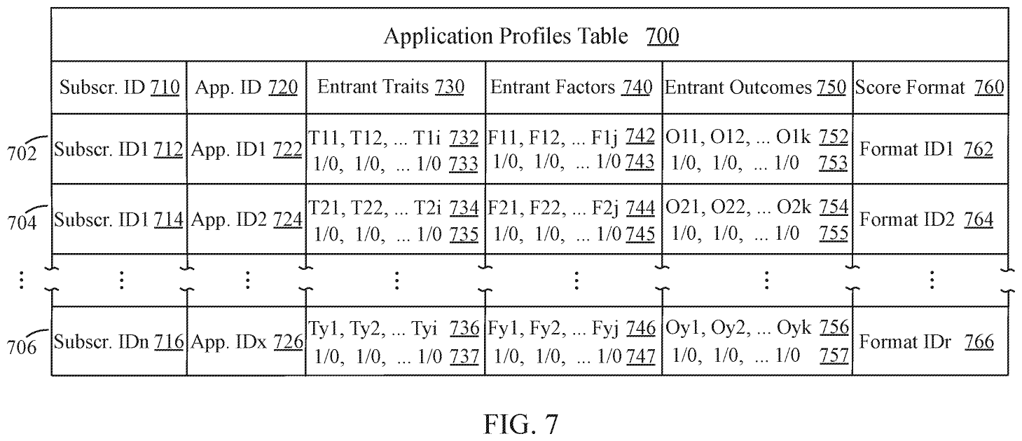

Turning now to FIG. 6, an exemplary embodiment of a risk/reward scoring system 600 capable of supporting a plurality of types of application-specific risk/reward scoring models is depicted. Risk/reward scoring system 600 comprises an entrant data manager 610, a feature extraction engine 620, an application-specific risk/reward modeler 630 and a multi-application risk/reward scoring engine 640. Feature extraction engine 620 comprises an entrant traits extractor 622, an entrant factors extractor 624, an entrant outcomes extractor 626, an application profiles database 627 and an entrant feature profiles database 628. Also referring to FIG. 7, which depicts an exemplary application profiles table 700, entrant traits extractor 622 and entrant factors extractor 624 access applications profiles database 627 and an application profiles table 700 therein, to determine which entrant traits and entrant factors are specified for inclusion for scoring a requested application-specific risk/reward score, and entrant traits extractor 622, entrant factors extractor 624, and entrant outcomes extractor 626 can access applications profiles database 627 and an application profiles table 700 therein, to determine which entrant traits, entrant factors and entrant outcomes are specified for training and testing a risk/reward scoring model for generating an associated application-specific risk/reward score.

Application profiles table 700 comprises application profile records 702, 704, . . . 706. Application profile records 702, 704, . . . 706 comprise a subscriber ID column 710, an application ID column 720, an entrant traits column 730, an entrant factors column 740, an entrant outcomes column 750 and a score format column 760. Subscriber IDs 712, 714, . . . 716 can identify subscribers of a risk/reward scoring system 600 who may submit application-specific risk/reward score requests 602 associated with application IDs 722, 724, . . . 726, respectively. Subscribers with business operations of varying types of transactional relationships or applications may subscribe to more than one type of application-specific risk/reward score. In exemplary application profiles table 700, the same subscriber ID1, of reference numbers 712 and 714, appears in records 702 and 704, respectively, and has associated therewith application ID1 722 and ID2 724, respectively. Each application profile record specifies which features are to be included when generating an application-specific risk/reward score, and further specifies which features are to be used when generating an application-specific risk/reward model. Application profile records 702, 704, . . . 706 comprise entrant traits fields 732, 734, . . . 736, respectively, and further respectively comprise entrant traits inclusion indicators 733, 735, . . . 737, such as a 1 or 0, for each entrant trait field in entrant traits fields 732, 734, . . . 736, respectively, wherein a 1 indicates that the associated entrant trait field is to be included and a 0 indicates that the associated entrant trait field is not to be included. Similarly, entrant factors fields 742, 744 , . . . 746 have associated entrant factors inclusion indicators 743, 745, . . . 747, respectively, and entrant outcomes fields 752, 754, . . . 756 have associated entrant outcomes inclusion indicators 753, 755, . . . 757, respectively. Score format column 760 comprises format IDs ID1 762, ID2 764, . . . IDr 766 which identify risk/reward score format rules for application profile records 702, 704, . . . 706 respectively. As such, risk/reward score formats can be defined for each application for each subscriber such that a subscriber may specify a format they desire for each of their subscribed application-specific risk/reward scoring applications. For example, a subscriber who operates an unmanned electric bike rental location may choose to have a “Go/No Go” or “Yes/No” risk/reward score format to automate permission or prevention of a transactional entity entering into a transactional relationship of renting an electric bike. Whereas in the case of a subscriber who personally operates a manned electric bike rental location, such a subscriber may choose to have a risk/reward score format which provides sufficient detail for them to consider scores for various evaluative considerations and measures in order to make a decision whether to enter into a transactional relationship of renting an electric bike to the transactional entity for which they received a sufficiently detailed risk/reward score format.

Returning to FIG. 3 in conjunction with FIG. 6, FIG. 3 depicts an exemplary entrant feature profiles table 300. Entrant traits extractor 622 accesses entrant data profiles database 612 to extract features associated with entrant traits for inclusion in an entrant feature profiles table 300. Alternatively, entrant traits extractor 622 could access a third party service, not shown in FIG. 6, such as that currently provided by IBM Personality Insights, a service provided by International Business Machines Corp., New Orchard Road, Armonk, N.Y., 10504, which can extract traits from data, such as traits associated with five primary personality characteristics, wherein each characteristic has six facets. In the exemplary table shown in FIG. 3, entrant feature profiles table 300 comprises 1, 2, . . . n entrant feature profile records 302, 304, . . . 306, respectively. Entrant feature profile records 302, 304, . . . 306 comprise an entrant ID in entrant ID column 310, namely ID1 312, ID2 314, . . . IDn 316, respectively, and further comprise entrant traits in entrant traits column 320, which comprises entrant traits fields for entrant feature profile records 302, 304 and 306, namely, T11, T12, . . . T1i 322, T21, T22, . . . T2i 324, . . . Tn1, Tn2, . . . , Tni 326, respectively, wherein entrant traits extractor 622 can store extracted entrant traits. Extracted entrant traits can be a plurality of traits which may provide a behavioral representation of the entrant and comprise one or more indicators which may be numeric. Entrant traits may further comprise an indication related to a confidence level of one or more indicators.

Entrant factors extractor 624 accesses entrant data profiles database 612 to extract features associated with entrant factors, such as those relating to situational and historical events, aspects, facts, representations and references, each of which may relate to an entrant, a potential transaction, or an entrant and a previous, current or potential transaction, for inclusion in an entrant feature profiles table 300. Entrant feature profile records 302, 304, . . . 306 comprise entrant factors in entrant factors column 330, which comprises entrant factors fields for entrant feature profile records 302, 304 and 306, namely, F11, F12, . . . , F1j 332, F21, F22, . . . , F2j 334, . . . Fn1, Fn2, Fnj 336, respectively, wherein entrant factors extractor 624 can store extracted entrant factors. Extracted entrant factors may provide a situational and historical representation of the entrant and include aspects of prior, current or potential transactions, and be a plurality of factors which may comprise one or more indicators which may be numeric. Entrant factors may further comprise an indication related to a confidence level of one or more indicators.

Entrant outcomes extractor 626 accesses entrant data profiles database 612 to extract features associated with entrant outcomes such as results relating to previous transactional relationships, activities, events and actions of an entrant for inclusion in an entrant feature profiles table 300. Entrant feature profile records 302, 304, . . . 306 comprise entrant outcomes in entrant outcomes column 340, which comprises entrant outcomes fields for entrant feature profile records 302, 304 and 306, namely, O11, O12, . . . O1k 342, O21, O22, . . . O2k 344, . . . On1, On2, . . . , Onk 346, respectively, wherein entrant outcomes extractor 626 can store extracted entrant outcomes. Extracted entrant outcomes may be a plurality of outcomes relating to prior activities of the entrant and may comprise one or more indicators which may be numeric. Entrant outcomes may further comprise an indication related to a confidence level of one or more indicators. Entrant outcomes may additionally be copied to, applied to or otherwise included in entrant factors wherein such entrant factors are effective in modeling and scoring outcomes.

Entrant data manager 610 comprises entrant data profile builder 611, entrant data profiles database 612 associated with a plurality of entrants, and exemplary sources of entrant data 613-618, where such data may originate from a plurality of sources of varying types and names, be organized in many various ways, and some or all may not reside within the risk/reward scoring system 600, and be accessed remotely therefrom. For exemplary and illustrative purposes, entrant data manager 610 is depicted in FIG. 6 having sources of entrant data 613-618 local to risk/reward scoring system 600 and organized by exemplary, common or general names relating to sources of such data. Such sources of entrant data 613-618 may comprise entrant provided data 613, third party authority data 614, social media data 615, direct feedback data 616, crowd-sourced ratings data 617 and other data 618. Each entrant can have associated therewith data from some or all sources of entrant data 613-618, which can be accessed by entrant data profile builder 611 to create an entrant data profile record, such as those depicted in FIG. 2, associated with the entrant, which may be stored in entrant data profiles database 612.

Turning briefly to FIG. 2, FIG. 2 depicts an exemplary entrant data profiles table 200, comprising 1, 2, . . . n entrant data profile records 202, 204, . . . 206, respectively. Entrant data profile records 202, 204, . . . 206 comprise an entrant ID in entrant ID column 210, namely ID1 212, ID2 214, . . . IDn 216, respectively, and further comprise entrant data fields in entrant data column 220, namely D11, D12, . . . D1m 222, D21, D22, . . . , D2m 224, . . . Dn1, Dn2, . . . , Dnm 226, respectively.

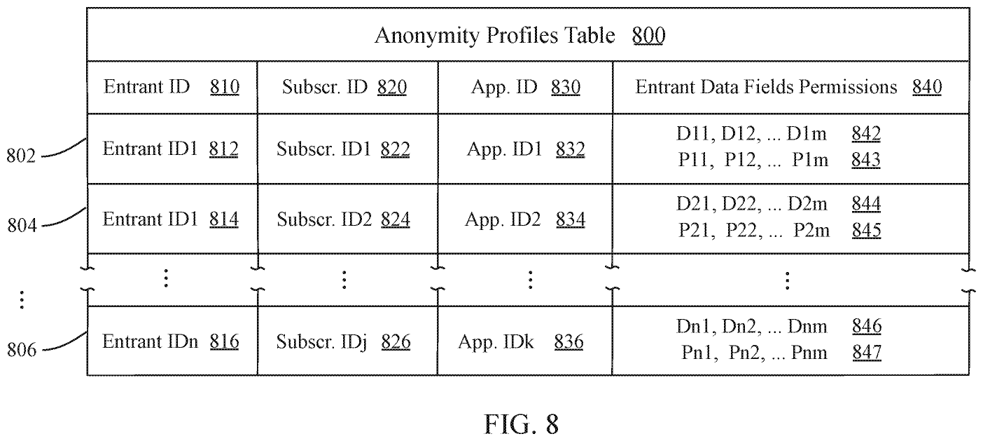

Returning to FIG. 6, entrant data manager 610 may further comprise an anonymity profiles database 619. Anonymity profiles database 619 may comprise anonymity and data privacy rules specified by a transactional entity submitted and entered into the risk/reward scoring system 600 as an entrant for scoring. Additionally, anonymity profiles database 619 may comprise anonymity and data privacy rules related to an application-specific data restriction. FIG. 8 depicts an exemplary anonymity profiles table 800 comprising an entrant ID column 810, subscriber ID column 820, an application ID column 830, an entrant data fields permissions column 840 and anonymity profiles records 802, 804, . . . 806 comprising entrant IDs 812, 814, . . . 816, respectively, subscriber IDs 822, 824, . . . 826, respectively, application IDs 832, 834, . . . 836, respectively, and entrant data fields/permissions 842/843, 844/845, . . . 846/847, respectively. Referring now to FIG. 6 in conjunction with FIG. 8, entrant data profile builder 611 can access anonymity profile records, 802, 804, . . . 806 comprised by anonymity profiles table 800 comprised by anonymity profiles database 619, and using data permissions 843, 845, . . . 847, govern its acquisition, access and use of entrant data which may be comprised in sources of entrant data 613-618. A transactional entity wishing to engage in a transaction with a subscriber, or otherwise establish a relationship with a risk/reward scoring system provider, may indicate entrant specified data permissions, which may then be received by the risk/reward scoring system directly or submitted by the subscriber as part of a risk/reward score request 602. When risk/reward scoring system 600 receives a risk/reward score request 602 comprising entrant specified data permissions, entrant data profile builder 611 can use such permissions to construct or update an anonymity profile record associated with the entrant, subscriber and application.

Application-specific risk/reward modeler 630 comprises training and testing traits 632, training and testing factors 634 and training and testing outcomes 636, risk/reward model builder 638 and candidate application-specific risk/reward model 639. Training and testing traits 632, training and testing factors 634 and training and testing outcomes 636 can be application-specific and include application-specific entrant features created by entrant traits extractor 622, entrant factors extractor 624 and entrant outcomes extractor 626 using an application profile record from application profiles table 700 of FIG. 7 located in application profiles database 627. Risk/reward model builder 638 of application-specific risk/reward modeler 630 can use machine learning to train and test a candidate application-specific risk/reward model 639, using training and testing traits 632 and training and testing factors 634 as input values and include training and testing outcomes 636 as target variables for modeling a relationship between these input values and target variables. To deploy a newly created or updated candidate model 639, risk/reward model builder 638 can deploy a completed candidate application-specific risk/reward model 639 to application-specific risk/reward models database 647 of multi-application risk/reward scoring engine 640.

Multi-application risk/reward scoring engine 640 comprises entrant scoring traits 642, entrant scoring factors 644, risk/reward scoring model 646, application-specific risk/reward models database 647, risk/reward score formatter 648 and format rules database 649. Multi-application risk/reward scoring engine 640 can load an application-specific model from application-specific models database 647 into risk/reward scoring model 646 and generate a risk/reward score for entrant scoring traits 642 and entrant scoring factors 644. Such an application-specific risk/reward score can then be formatted by risk/reward score formatter 648 using format rules retrieved by from format rules database 649. Format rules database 649 can be established from columns 710, 720 and 760 of application profiles table 700 of FIG. 7 from applications profiles database 627, or alternatively, format rules can be accessed directly therefrom by risk/reward score formatter 648.

Where a market preference for a known or traditional scoring algorithm and resulting preferred known or traditional score, such as a FICO score for example, is established, an embodiment may be implemented wherein entrant data manager 610 sources such a known or traditional score from a known or traditional source. Alternatively, an embodiment may be implemented wherein feature extractor 620 can calculate a known, traditional or similar score using the same or a similar algorithm to that commonly used to calculate the known or traditional score. This same or similar, known or traditional score may then be used as an entrant factor, comprised in entrant feature profiles database 628, for use as an entrant scoring factor 644, and be mapped, directly or indirectly, by the risk/reward scoring model 646 to an evaluative consideration or evaluative measure as a score, or a component thereof within a risk/reward score 648, and additionally be used as an entrant training and testing factor 634 by an application-specific risk/reward modeler 630 and a risk/reward model builder 638 to be model its relationship to evaluative considerations and evaluative measures. As such, this same or similar, known or traditional score may then be used as an entrant scoring factor for both scoring evaluative considerations and evaluative measures, and be additionally mapped, directly or indirectly, to an evaluative consideration and evaluative measure within a risk/reward score 648.

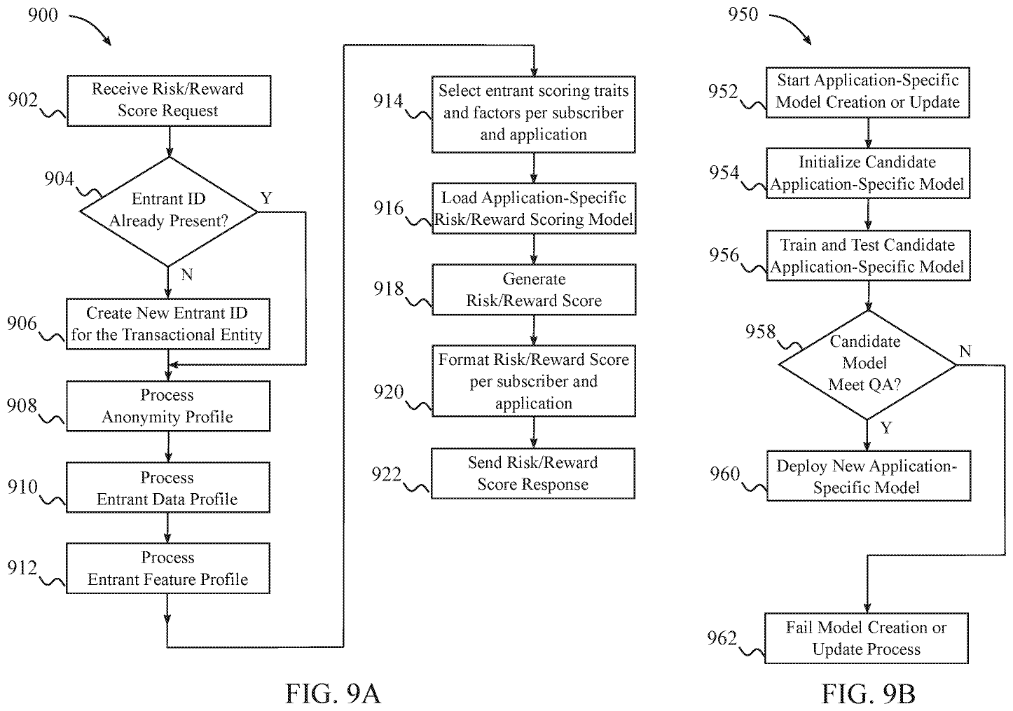

The major functions of risk/reward scoring system 600 can be grouped into three primary sections of functions, namely, a data acquisition and cleaning section 604 which comprises entrant data manager 610, a feature extraction section 605 which comprises feature extraction engine 620, and a modeling and scoring 606 section which comprises application-specific risk/reward modeler 630 and multi-application risk/reward scoring engine 640. FIG. 9a depicts an exemplary flow diagram 900 of a risk/reward score request 602 and response 608 of risk/reward scoring system 600. Referring to FIG. 9a in addition to FIG. 6, when a risk/reward score request 602 to score a transactional entity is received in step 902 by risk/reward scoring system 600, entrant data profile builder 611 of entrant data manager 610 of data acquisition and cleaning section 604 checks to see in step 904 if the transactional entity to be scored is already an entrant in the risk/reward scoring system 600 as evidenced by the presence of an associated entrant ID and entrant data profile in the entrant data profiles database 612. If one is present, processing of the risk/reward score request proceeds to step 908, otherwise entrant data profile builder 611 creates a new entrant ID for the transactional entity in step 906, upon which the transactional entity becomes an entrant. In step 908, entrant data profile builder 611 processes an anonymity profile record in the anonymity profiles database 619 for the transactional entity. In step 910 entrant data profile builder 611, using rules governing data usage and disclosure comprised by the anonymity profile associated with the entrant, processes an entrant data profile record in entrant data profile table 200 of FIG. 2 comprised in entrant data profiles database 612. Next, in step 912, feature extraction engine 620 of feature extraction section 605 processes an entrant feature profile record in entrant feature profile table 300 of FIG. 3 comprised in entrant feature profiles database 628. In step 914, multi-application risk/reward scoring engine 640 of modeling and scoring section 606 selects entrant scoring traits 642 and entrant scoring factors 644 for the entrant from the entrant feature profiles database 628 per application profiles record of FIG. 7 relating to the subscriber ID and application ID indicated in the risk/reward score request 602. In step 916, multi-application risk/reward scoring engine 640 loads an application-specific risk reward scoring model 646 from application-specific models database 647 as indicated in the risk/reward score request 602. In step 918, risk/reward scoring model 646 of multi-application risk/reward scoring engine 640 generates a risk/reward score which may comprise a plurality of scores of various evaluative considerations and/or evaluative measures, some of which may be statistical, probabilistic or predictive in nature and comprise measures of potential outcomes for a potential transaction in view of a transactional relationship with the entrant (transactional entity). In step 920, risk/reward score formatter 648 formats the risk/reward score generated by risk/reward scoring model 646, wherein such format can be specified by format rules database 649 as indicated by the subscriber and application of the risk/reward score request 602. Format rules database 649 can be established from columns 710, 720 and 760 of application profiles table 700 of FIG. 7 from applications profiles database 627, or alternatively, format rules can be accessed directly therefrom by risk/reward score formatter 648. Lastly, in step 922, multi-application risk/reward scoring engine 640 sends a risk/reward score response 608.

FIG. 9b depicts an exemplary flow diagram of a process 950 to create or update an application-specific risk/reward scoring model 646 for risk/reward scoring system 600, also referred to as a modeling process, which may comprise model training, model validation, model cross-validation and model testing. Referring to FIG. 9b and FIG. 6, as additional data is acquired by entrant data manager 610 and stored in entrant data profiles database 612, and further processed by feature extraction engine 620 and stored in entrant feature profiles database 628, modeling process 950 can be initiated periodically such that application-specific risk/reward modeler 630 updates an application-specific risk/reward model comprised in application-specific models database 647 periodically for use as an updated risk/reward scoring model 646. To maintain application-specifics models representing, at least in part, entrant data and/or features extracted therefrom currently comprised within the risk/reward scoring system 600, modeling process 950 can be initiated upon at least one of a plurality of events. Such events may comprise but are not limited to, the acquisition of additional entrant data and/or features extracted therefrom relating to an application-specific risk/reward model exceeding a predetermined percentage portion of the total entrant data and/or features extracted therefrom relating to the application-specific risk/reward model within the system 600, the acquisition of additional entrant data and/or features extracted therefrom relating to an application-specific risk/reward model exceeding a predetermined amount, the expiration of a predetermined period of time since the last update of a given application-specific risk/reward scoring model, a quality assurance initiated update for a given application-specific risk/reward scoring model, a newly defined application-specific model, newly defined or redefined entrant features for a given application-specific risk/reward scoring model, or, newly defined or redefined evaluative considerations or evaluative measures for a given application-specific risk/reward scoring model. Alternatively, process 950 can be a continual process, such that the process repeats after completion.

Modeling process 950 begins in step 952 with the start of a application-specific model 639 creation or update. In step 954, risk/reward model builder 638 initializes candidate application-specific model 639 for creation or updating and deployment to application-specific models database 647. In step 956, risk/reward model builder 638 trains and tests candidate application-specific model 639. Such training and testing 956 may comprise model training, model validation, model cross-validation and model testing. Model training and testing 956 of an embodiment of risk/reward scoring system 600 may, in the case of an update to an application-specific model comprised in application-specific models database 647, employ incremental learning, wherein recently acquired entrant data and features extracted therefrom not previously used to train the application-specific model is now used to incrementally train and update candidate application-specific model 639. Alternatively, in another embodiment, risk/reward model builder 638 in model training and testing step 956 may use a comprehensive set of entrant data and features extracted therefrom which may comprise entrant data and features extracted therefrom that was previously used to train and test the application-specific model in addition to entrant data and features extracted therefrom that is newly acquired and not previously used, to train and test candidate risk/reward model 639 for deployment as an application-specific model. Of course, in the case of a never previously created application-specific model, all entrant data and features extracted therefrom will be new and not previously used with regard to the application-specific model. Model training and testing 956 may be an iterative process based on results of testing. Once model training and testing 956 has concluded, step 958 checks if candidate application-specific model 639 meets quality guidelines. If such quality guidelines are met, then candidate application-specific model 639 may be deployed to application-specific models database 647 in step 960. If candidate application-specific model 639 does not meet quality guidelines, then the model creation or update process 950 is failed in step 962, and candidate risk/reward model 639 may not be deployed to application-specific models database 647.

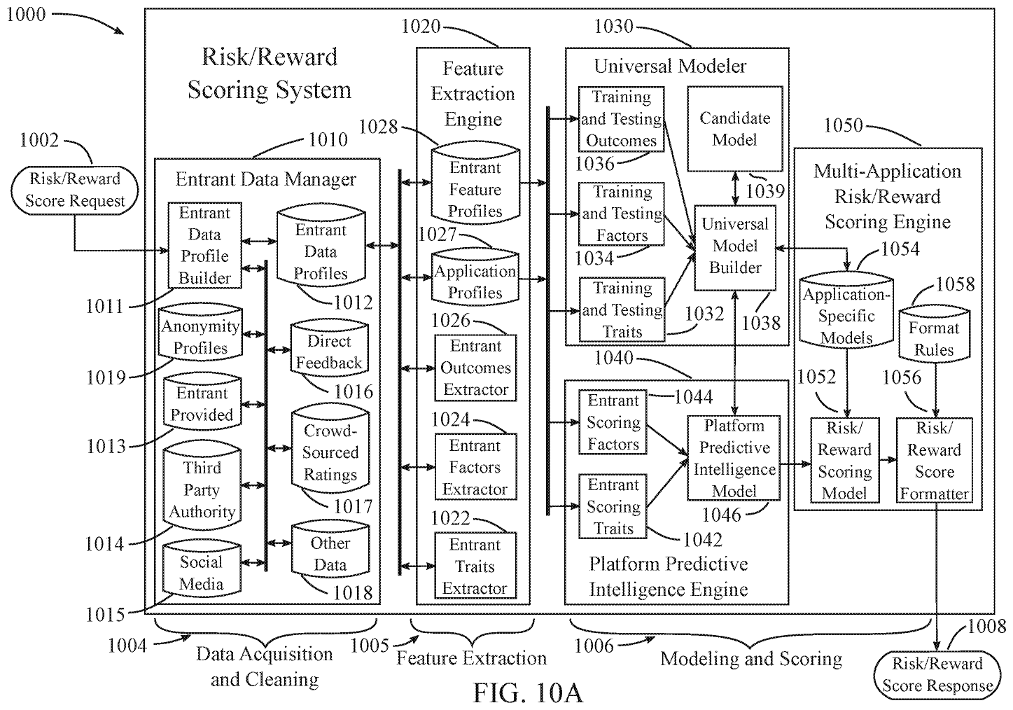

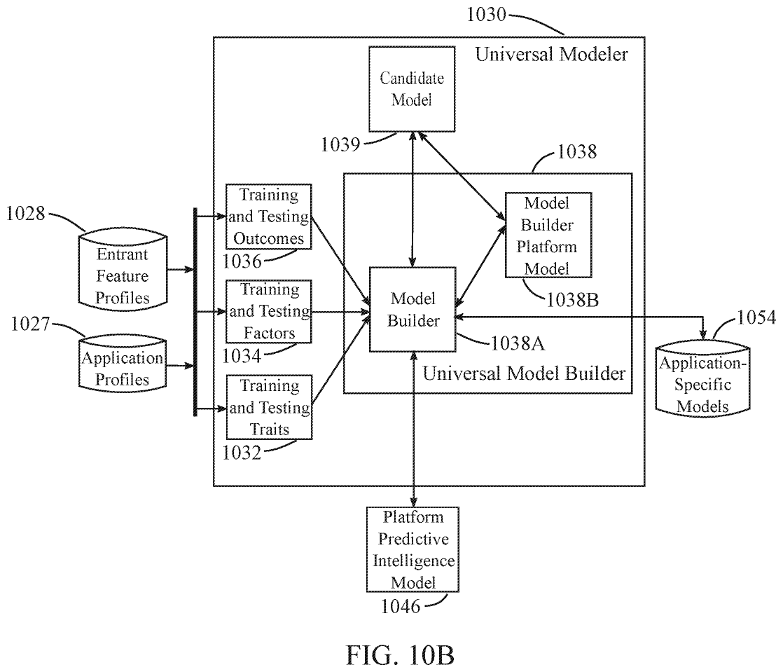

Turning now to FIG. 10A, an exemplary embodiment of a risk/reward scoring system 1000 comprising a two-tier model architecture supporting a plurality of types of application-specific risk/reward scoring models in an applications tier and utilizing a platform predictive intelligence model in a platform tier is depicted. Risk/reward scoring system 1000 comprises an entrant data manager 1010, a feature extraction engine 1020, a universal modeler 1030, a platform predictive intelligence engine 1040 and a multi-application risk/reward scoring engine 1050. Entrant data manager 1010 comprises entrant data profile builder 1011, entrant data profiles database 1012 associated with a plurality of entrants, and exemplary sources of entrant data, 1013-1018, where such data may originate from a plurality of sources of varying types and names, be organized in many various ways, and some or all may not reside within the risk/reward scoring system 600, and be accessed remotely therefrom. For exemplary and illustrative purposes, entrant data manager 1010 is depicted in FIG. 10 having sources of entrant data, 1013-1018, organized by exemplary, common or general names relating to sources of such data. Such sources of entrant data, 1013-1018, may comprise entrant provided data 1013, third party authority data 1014, social media data 1015, direct feedback data 1016, crowd-sourced ratings data 1017 and other data 1018. Each entrant can have sources of entrant data, 1013-1018, which can be accessed by entrant data profile builder 1011 to create an entrant data profile record, such as those depicted in FIG. 2, associated with the entrant, which may be stored in entrant data profiles database 1012.

Turning briefly to FIG. 2, FIG. 2 depicts an exemplary entrant data profiles table 200, comprising 1, 2, . . . n entrant data profile records 202, 204, . . . 206, respectively. Entrant data profile records 202, 204, . . . 206 comprise an entrant ID in entrant ID column 210, namely ID1 212, ID2 214, . . . IDn 216, respectively, and further comprise entrant data fields in entrant data column 220, namely D11, D12, . . . D1m 222, D21, D22, D2m 224, . . . Dn1, Dn2, Dnm 226, respectively.

Returning to FIG. 10, entrant data manager 1010 may further comprise an anonymity profiles database 1019. Anonymity profiles database 1019 may comprise anonymity and data privacy rules specified by a transactional entity submitted and entered into the risk/reward scoring system 1000 as an entrant for scoring. Additionally, anonymity profiles database 1019 may comprise anonymity and data privacy rules related to an application-specific data restriction. FIG. 8 depicts an exemplary anonymity profiles table 800 comprising an entrant ID column 810, subscriber ID column 820, an application ID column 830, an entrant data fields permissions column 840 and anonymity profiles records 802, 804, . . . 806 comprising entrant IDs 812, 814, . . . 816, respectively, subscriber IDs 822, 824, . . . 826, respectively, application IDs 832, 834, . . . 836, respectively, and entrant data fields/permissions 842/843, 844/845, . . . 846/847, respectively. Referring now to FIG. 10 in conjunction with FIG. 8, entrant data profile builder 1011 can access anonymity profile records, 802, 804, . . . 806 comprised by anonymity profiles table 800 comprised by anonymity profiles database 1019, and using data permissions 843, 845, . . . 847, govern its acquisition, access and use of entrant data which may be comprised in sources of entrant data 1013 - 1018. A transactional entity wishing to engage in a transaction with a subscriber, or otherwise establish a relationship with a risk/reward scoring system provider, may indicate entrant specified data permissions, which may then be received by the risk/reward scoring system directly or submitted by the subscriber as part of a risk/reward score request 1002. When risk/reward scoring system 1000 receives a risk/reward score request 1002 comprising entrant specified data permissions, entrant data profile builder 1011 can use such permissions to construct or update an anonymity profile record associated with the entrant, subscriber and application.

Feature extraction engine 1020 comprises an entrant traits extractor 1022, an entrant factors extractor 1024, an entrant outcomes extractor 1026, an application profiles database 1027 and an entrant feature profiles database 1028. Also referring to FIG. 7, which depicts an exemplary application profiles table 700, entrant traits extractor 1022 and entrant factors extractor 1024 access applications profiles database 1027 and an application profiles table 700 therein, to determine entrant traits and entrant factors specified for scoring a requested application-specific risk/reward score, and entrant traits extractor 1022, entrant factors extractor 1024, and entrant outcomes extractor 1026 can access applications profiles database 1027 and an application profiles table 700 therein, to determine entrant traits, entrant factors and entrant outcomes specified to for training and testing a platform predictive intelligence model and a risk/reward scoring model for generating an associated application-specific risk/reward score.

Application profiles table 700 comprises application profile records 702, 704, . . . 706. Application profile records 702, 704, . . . 706 comprise a subscriber ID column 710, an application ID column, an entrant traits column 730, an entrant factors column 740, an entrant outcomes column 750 and a score format column 760. Subscriber IDs 712, 714, . . . 716 can identify subscribers of a risk/reward scoring system 1000 who may submit application-specific risk/reward score requests 1002 associated with application IDs 722, 724, . . . 726, respectively. Subscribers with business operations of varying types of transactional relationships or applications may subscribe to more than one type of application-specific risk/reward score. In exemplary application profiles table 700, the same subscriber ID1, of reference numbers 712 and 714, appears in records 702 and 704, respectively, and has associated therewith application ID1 722 and ID2 724, respectively. Each application profile record specifies which features are to be included when generating an application-specific risk/reward score, and further specifies which features are to be used when generating an application-specific risk/reward model. Application profile records 702, 704, . . . 706 comprise entrant traits fields 732, 734, . . . 736, respectively, and further respectively comprise entrant traits inclusion indicators 733, 735, . . . 737, such as a 1 or 0, for each entrant trait field in entrant traits fields 732, 734, . . . 736, respectively, wherein a 1 indicates that the associated entrant trait filed is to be included and a 0 indicates that the associated entrant trait field is not to be included. Similarly, entrant factors fields 742, 744, . . . 746 have associated entrant factors inclusion indicators 743, 745, . . . 747, respectively, and entrant outcomes fields 752, 754, . . . 756 have associated entrant outcomes inclusion indicators 753, 755, . . . 757, respectively. Score format column 760 comprises format IDs ID1 762, ID2 764 and IDr 766 which identify risk/reward score format rules for application profile records 702, 704, . . . 706 respectively. As such, risk/reward score formats can be defined for each application for each subscriber such that a subscriber may specify a format they desire for each of their subscribed application-specific risk/reward scoring applications. For example, a subscriber who operates an unmanned electric bike rental location may choose to have a “Go/No Go” or “Yes/No” risk/reward score format to automate permission or prevention a transactional entity entering into a transactional relationship of renting an electric bike. Whereas in the case of a subscriber who personally operates a manned electric bike rental location, such a subscriber may choose to have a risk/reward score format which provides sufficient detail for them to consider scores for various evaluative considerations and measures in order to make a decision whether to enter into a transactional relationship of renting an electric bike to the transactional entity for which they received a sufficiently detailed risk/reward score format.

Returning to FIG. 3 in conjunction with FIG. 10, FIG. 3 depicts an exemplary entrant feature profiles table 300. Entrant traits extractor 1022 accesses entrant data profiles database 1012 to extract features associated with entrant traits for inclusion in an entrant feature profiles table 300. Alternatively, entrant traits extractor 1022 could access a third party service, not shown in FIG. 10, such as that currently provided by IBM Personality Insights, a service provided by International Business Machines Corp., New Orchard Road, Armonk, N.Y., 10504, which can extract traits from data, such as traits associated with five primary personality characteristics, wherein each characteristic has six facets. In the exemplary table shown in FIG. 3, entrant feature profiles table 300 comprises 1, 2, . . . n entrant feature profile records 302, 304, . . . 306, respectively. Entrant feature profile records 302, 304, . . . 306 comprise an entrant ID in entrant ID column 310, namely ID1 312, ID2 314, . . . IDn 316, respectively, and further comprise entrant traits in entrant traits column 320, which comprises entrant traits fields for entrant feature profile records 302, 304 and 306, namely, T11, T12, . . . T1i 322, T21, T22, T2i 324, . . . Tn1, Tn2, . . . , Tni 326, respectively, wherein entrant traits extractor 1022 can store extracted entrant traits. Extracted entrant traits can be a plurality of traits which may provide a behavioral representation of the entrant and comprise one or more indicators which may be numeric. Entrant traits may further comprise an indication related to a confidence level of one or more indicators.

Entrant factors extractor 1024 accesses entrant data profiles database 1012 to extract features associated with entrant factors, such as those relating to situational and historical events, aspects, facts, representations and references, each of which may relate to an entrant, a potential transaction, or an entrant and a previous, current or potential transaction, for inclusion in an entrant feature profiles table 300. Entrant feature profile records 302, 304, . . . 306 comprise entrant factors in entrant factors column 330, which comprises entrant factors fields for entrant feature profile records 302, 304 and 306, namely, F11, F12, . . . F1j 332, F21, F22, . . . F2j 334, . . . Fn1, Fn2, . . . , Fnj 336, respectively, wherein entrant factors extractor 1024 can store extracted entrant factors. Extracted entrant factors may provide a situational and historical representation of the entrant and include aspects of prior, current or potential transactions, and be a plurality of factors which may comprise one or more indicators which may be numeric. Entrant factors may further comprise an indication related to a confidence level of one or more indicators.

Entrant outcomes extractor 1026 accesses entrant data profiles database 1012 to extract features associated with entrant outcomes such as results relating to previous transactional relationships, activities, events and actions of an entrant for inclusion in an entrant feature profiles table 300. Entrant feature profile records 302, 304, . . . 306 comprise entrant outcomes in entrant outcomes column 340, which comprises entrant outcomes fields for entrant feature profile records 302, 304 and 306, namely, O11, O12, . . . O1k 342, O21, O22, . . . O2k 344, . . . On1, On2, . . . , Onk 346, respectively, wherein entrant outcomes extractor 1026 can store extracted entrant outcomes. Extracted entrant outcomes may be a plurality of outcomes relating to prior activities of the entrant and may comprise one or more indicators which may be numeric. Entrant outcomes may further comprise an indication related to a confidence level of one or more indicators. Entrant outcomes may additionally be copied to, applied to or otherwise included in entrant factors wherein such entrant factors are effective in modeling and scoring outcomes.

Universal modeler 1030 comprises training and testing traits 1032, training and testing factors 1034, training and testing outcomes 1036, universal model builder 1038 and candidate model 1039. Universal model builder 1038 of universal modeler 1030 can use machine learning to train and test a candidate model 1039. Such a candidate model can be an application-specific model for deployment to multi-application risk/reward scoring engine 1050 or can be a platform predictive intelligence model for deployment to platform predictive intelligence engine 1040. FIG. 10B depicts universal model builder 1038 of universal modeler 1030 in additional detail, wherein universal model builder 1038 comprises a model builder 1038A and model builder platform model 1038B. Referring to both FIG. 10A and FIG. 10B, model builder 1038A of universal model builder 1038 trains and tests a candidate model 1039 for a platform predictive intelligence model 1046 using training and testing traits 1032 relating to all or a plurality of applications, and training and testing factors 1034 relating to all or a plurality of applications, as input values and uses training and testing outcomes 1036 relating to all or a plurality of applications, as target variables for modeling a relationship between these input values and target variables. As such, the platform predictive intelligence model 1046 can be trained using a set of entrant feature profiles representing all or a plurality of applications, which can also be referred to as a set of platform inclusive entrant feature profiles. Additionally, entrant traits fields, entrant factors fields and entrant outcome fields within entrant feature profiles can be indicated as platform inclusive, wherein inclusion fields 733, 735, . . . 737, 743, 745, . . . 747, and 753, 755, . . . 757 of application profiles table 700 of FIG. 7, can additionally specify a value, such as “P”, to indicate an associated feature is to be included as platform inclusive in the generation of a candidate platform predictive intelligence model. The output from such a platform inclusively trained platform predictive intelligence model 1046, when presented with an entrant's platform inclusive entrant traits and an entrant's platform inclusive entrant factors, can be called a platform predictive intelligence entrant vector, or simply, an entrant vector.

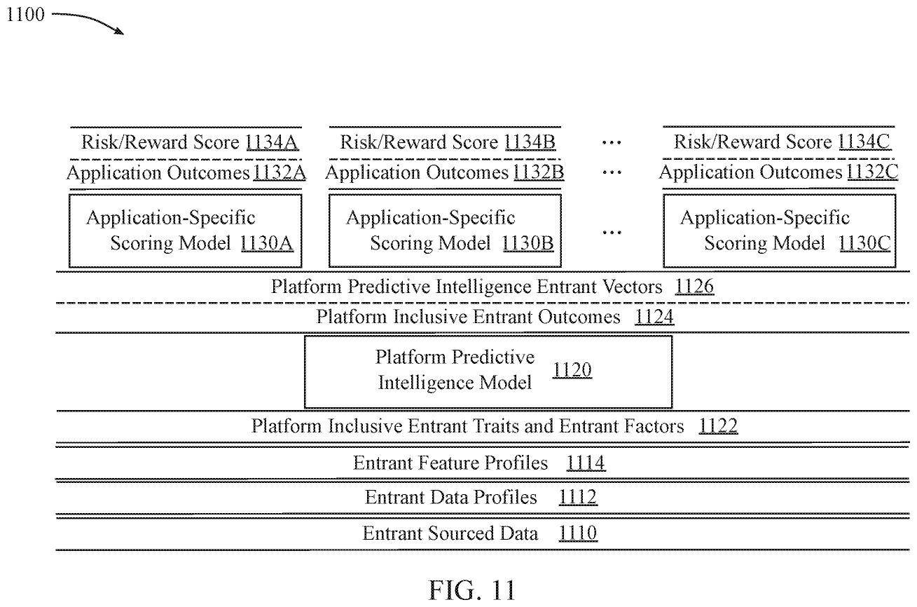

FIG. 11 depicts an exemplary view 1100 of portions of risk/reward scoring system 1000 which illustrates the two-tier modeling architecture thereof, and the platform predictive intelligence entrant vector as an intermediary modeling and scoring stage between the two tiers, and its role in providing a unified and shared platform for a plurality of application-specific risk/reward models. Referring to both FIG. 11 and FIG. 10A, FIG. 11 depicts data and derivative data 1110, 1112, 1114, 1122, 1124, 1126, 1132A, b and c, and 1134 a, b and c, separated by two model tiers, namely, a platform tier comprising a predictive intelligence model 1120 and an application tier comprising application-specific scoring models 1130 a, b and c. Entrant sourced data 1110 is data that can be sourced from sources of entrant data, 1013-1018 and is processed by entrant profile builder 1011 to generate entrant data profiles 1112, which is in turn is processed by entrant traits extractor 1022, entrant factors extractor 1024 and entrant outcomes extractor 1026 to generate entrant feature profiles 1114. Entrant feature profiles 1114 can comprise entrant feature profiles relating to a plurality of applications, and entrant features therein can additionally relate to a plurality of applications. When not selected and separated with respect to a given application or set of applications, and rather taken as a whole, such entrant feature profiles, and features therein, can be referred to as being platform inclusive. For example, entrant traits and entrant factors 1122 are referred to as platform inclusive entrant traits and entrant factors 1122 to indicate no removal of entrant traits or entrant factors specific to one or more applications has occurred. When platform predictive intelligence model 1120 is created or updated, platform inclusive entrant features can be used for training and testing, as indicated in FIG. 11 by platform inclusive entrant traits and entrant factors 1122 and platform inclusive entrant outcomes 1124. A platform predictive intelligence model 1120 can thereby be trained and tested to produce a statistical, probabilistic and predictive set of platform inclusive entrant outcomes when presented with a set of platform inclusive entrant traits and entrant factors. A so produced statistical, probabilistic and predictive set of platform inclusive entrant outcomes can also be referred to as a platform predictive intelligence entrant vector 1126 and is shown in FIG. 11 as platform predictive intelligence entrant vectors 1126.

Platform predictive intelligence model 1120 of FIGS. 11, and 1046 of FIG. 10A, is a first tier of a two-tier modeling architecture of exemplary view 1100 and system 1000, respectively. A second tier shown in view 1100 of FIG. 11 comprises application-specific scoring models 1130A, 1130B and 1130C and corresponds to application-specific scoring models comprised by multi-application risk/reward scoring engine 1050 of system 1000 of FIG. 10A. When application-specific scoring models 1130A, 1130B and 1130C are created or updated, platform predictive intelligence entrant vectors, or entrant vectors can be used as inputs, and entrant outcomes, selected using entrant outcomes inclusion fields 753, 755 . . . 757 of applications profiles table 700 of FIG. 7 and of applications profiles database 1027 for a specific application relating to the application-specific model to be created or updated, can be used as target output variables to train and test the application-specific model. An application-specific scoring model can thereby be trained and tested to produce a statistical, probabilistic and predictive set of application-specific entrant outcomes when presented with an entrant vector 1126, wherein the entrant vector 1126 is generated by platform predictive intelligence model 1120 when presented with a set of platform inclusive entrant traits and entrant factors 1122 for an entrant. Such a statistical, probabilistic and predictive set of application-specific entrant outcomes corresponds to evaluative considerations and evaluative measures related to a potential transactional relationship in view of the entrant and are a risk/reward score as shown in FIG. 11, 1134A, 1134B and 1134C.

Referring to FIG. 10A and FIG. 10B, application-specific model creation and updating is discussed in additional detail. Model builder 1038A of universal model builder 1038 trains and tests a candidate model 1039 for an application-specific risk/reward model 1052 by first creating or loading a platform predictive intelligence model into model builder platform model 1038B. Then model builder 1038A generates training and testing entrant vectors as outputs from model builder platform model 1038B by inputting platform inclusive training and testing traits 1032 and platform inclusive training and testing factors 1034 to model builder platform model 1038B, wherein entrant traits inclusion fields 733, 735, . . . 737 and entrant factors inclusion fields 743, 745, . . . 747 of application profiles table 700 of FIG. 7, can additionally specify a value, such as “P”, to indicate an associated trait or factor is to be included as platform inclusive. The resulting training and testing entrant vectors are then used as inputs, and application-specific training and testing outcomes 1036, selected per outcomes inclusion fields 753, 755, . . . 757 of application profiles table 700 of FIG. 7, are used as target variables for modeling an application-specific relationship (model) between these input values and target variables. To deploy a newly created or updated candidate application-specific model 1039, universal model builder 1038A can deploy a completed candidate application-specific risk/reward model 1039 to application-specific risk/reward models database 1054 of multi-application risk/reward scoring engine 1050.

Referring to FIG. 10A, platform predictive intelligence engine 1040 comprises entrant scoring traits 1042, entrant scoring factors 1044 and platform predictive intelligence model 1046. Platform predictive intelligence model 1046 accepts platform inclusive entrant scoring traits 1042 and platform inclusive entrant scoring factors 1044 as inputs, and outputs a platform predictive intelligence entrant vector which can be input into risk/reward scoring model 1052 of multi-application risk/reward scoring engine 1050 for generation of an application-specific risk/reward score.

Multi-application risk/reward scoring engine 1050 comprises risk/reward scoring model 1052, application-specific models database 1054, risk/reward score formatter 1056 and format rules database 1058. Multi-application risk/reward scoring engine 1050 can load an application specific model from database 1054 into risk/reward scoring model 1052 and generate a risk/reward score for an entrant associated with an entrant vector generated by platform predictive intelligence model 1046. Such an application-specific risk/reward score can then be formatted by risk/reward score formatter 1056 using format rules retrieved by from format rules database 1058. Format rules database 1058 can be established from columns 710, 720 and 760 of application profiles table 700 of FIG. 7 from applications profiles database 1027, or alternatively, format rules can be accessed directly therefrom by risk/reward score formatter 1058.

Where a market preference for a known or traditional scoring algorithm and resulting preferred known or traditional score, such as a FICO score for example, is established, an embodiment may be implemented wherein entrant data manager 1010 sources such a known or traditional score from a known or traditional source. Alternatively, an embodiment may be implemented wherein feature extractor 1020 can calculate a known, traditional or similar score using the same or a similar algorithm to that commonly used to calculate the known or traditional score. This same or similar, known or traditional score may then be used as an entrant factor, comprised in entrant feature profiles database 1028, for use as an entrant scoring factor 1044, be mapped, directly or indirectly, by the platform predictive intelligence model 1046 to a value comprised by the platform predictive intelligence vector. The application-specific risk/reward model 1052 can in turn map, directly or indirectly, the same or similar, known or traditional score to an evaluative consideration or evaluative measure as a score, or a component thereof within a risk/reward score 1056, and additionally be used as an entrant training and testing factor 1034 by universal modeler 1030 and universal model builder 1038 to model its relationship to platform predictive intelligence vectors and in turn to evaluative considerations and evaluative measures. As such, this same or similar, known or traditional score may then be used as an entrant scoring factor 1044 for both scoring evaluative considerations and evaluative measures, and be mapped, directly or indirectly, to an evaluative consideration and evaluative measure within a risk/reward score 1056.

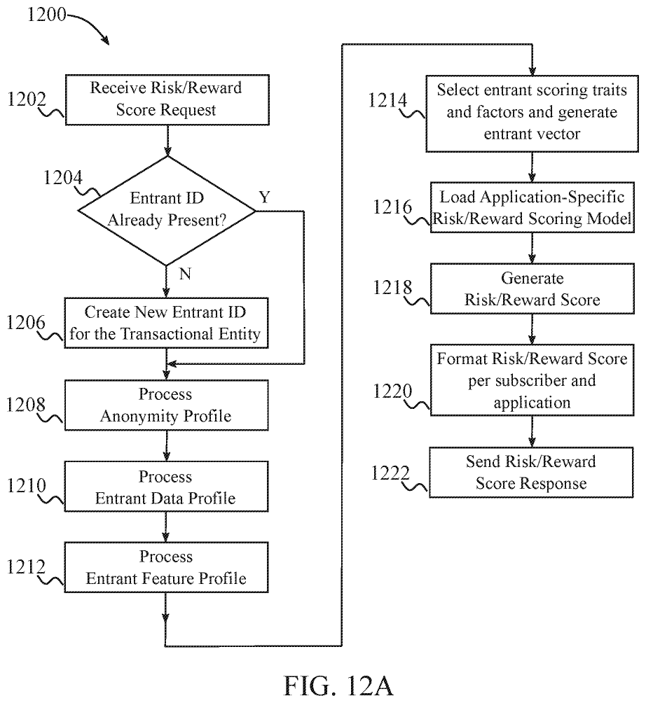

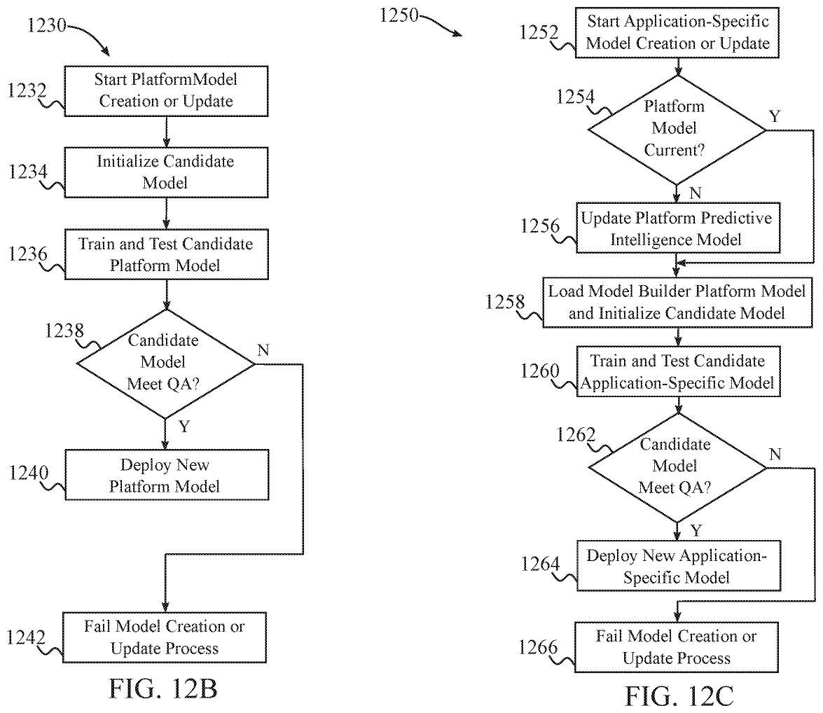

The major functions of risk/reward scoring system 1000 can be grouped into three primary sections of functions, namely, a data acquisition and cleaning section 1004 which comprises entrant data manager 1010, a feature extraction section 1005 which comprises feature extraction engine 1020, and a modeling and scoring 1006 section which comprises universal modeler 1030, platform predictive intelligence engine 1040 and multi-application risk/reward scoring engine 1050. FIG. 12A depicts an exemplary flow diagram 1200 of a risk/reward score request 1002 and response 1008 of risk/reward scoring system 1000. Referring to FIG. 12A in addition to FIG. 10A, when a risk/reward score request 1002 to score a transactional entity is received in step 1202 by risk/reward scoring system 1000, entrant data profile builder 1011 of entrant data manager 1010 of data acquisition and cleaning section 1004 checks to see in step 1204 if the transactional entity to be scored is already an entrant in the risk/reward scoring system 1000 as evidenced by the presence of an associated entrant ID in the entrant data profiles database 1012. If one is present, processing of the risk/reward score request 1002 proceeds to step 1208, otherwise entrant data profile builder 1011 creates a new entrant ID for the transactional entity in step 1206, upon which the transactional entity becomes an entrant. In step 1208, entrant data profile builder 1011 processes an anonymity profile record in the anonymity profiles database 1019 for the entrant. In step 1210 entrant data profile builder 1011, using rules governing data usage and disclosure comprised by the anonymity profile associated with the entrant, processes an entrant data profile record in entrant data profile table 200 of FIG. 2 comprised in entrant data profiles database 1012. Next, in step 1212, feature extraction engine 1020 of feature extraction section 1005 processes an entrant feature profile record in entrant feature profile table 300 of FIG. 3 comprised in entrant feature profiles database 1028. In step 1214, platform predictive intelligence engine 1040 of modeling and scoring section 1006 selects platform inclusive entrant traits 1042 and platform inclusive entrant factors 1044 and platform predictive intelligence model 1046 generates an entrant vector. In step 1216, multi-application risk/reward scoring engine 1050 of modeling and scoring section 1006 loads an application-specific risk reward scoring model 1046 from application-specific models database 1054 as indicated in the risk/reward score request 1002. In step 1218, risk/reward scoring model 1052 of multi-application risk/reward scoring engine 1050 generates a risk/reward score which may comprise a plurality of scores of various evaluative considerations and/or evaluative measures, some of which may be statistical, probabilistic or predictive in nature and comprise measures of potential outcomes for a potential transaction in view of a transactional relationship with the entrant (transactional entity). In step 1220, risk/reward score formatter 1056 formats the risk/reward score generated by risk/reward scoring model 1052, wherein such format can be specified by format rules database 1058 as indicated by the subscriber and application of the risk/reward score request 1002. Format rules database 1058 can be established from columns 710, 720 and 760 of application profiles table 700 of FIG. 7 from applications profiles database 1027, or alternatively, format rules can be accessed directly therefrom by risk/reward score formatter 1056. Lastly, in step 1222, multi-application risk/reward scoring engine 1050 sends a risk/reward score response 1008.

FIG. 12B depicts an exemplary flow diagram of a process 1230 to create or update a platform predictive intelligence model 1046 for risk/reward scoring system 1000, also referred to as a modeling process, which may comprise model training, model validation, model cross-validation and model testing. Referring to FIG. 12B and FIG. 10A, as additional data is acquired by entrant data manager 1010 and stored in entrant data profiles database 1012, and further processed by feature extraction engine 1020 and stored in entrant feature profiles database 1028, modeling process 1230 can be initiated periodically such that universal modeler 1030 updates platform predictive intelligence model 1046 periodically. To maintain platform predictive intelligence model 1046 representing, at least in part, entrant data and/or features extracted therefrom currently comprised within the risk/reward scoring system 1000, modeling process 1230 can be initiated upon at least one of a plurality of events. Such events may comprise but are not limited to, the acquisition of additional entrant data and/or features extracted therefrom relating to platform predictive intelligence model 1046 exceeding a predetermined percentage portion of the total entrant data and/or features extracted therefrom relating to the platform predictive intelligence model 1046 within the system 1000, the acquisition of additional entrant data and/or features extracted therefrom relating to platform predictive intelligence model 1046 exceeding a predetermined amount, the expiration of a predetermined period of time since the last update of platform predictive intelligence model 1046, a quality assurance initiated update for platform predictive intelligence model 1046, newly defined or redefined entrant features, or, newly defined or redefined evaluative considerations or evaluative measures relating to the platform predictive intelligence vector of platform predictive intelligence model 1046. Alternatively, process 1230 can be a continual process, such that the process repeats after completion.

Modeling process 1230 begins in step 1232 with the start of a candidate model 1039 creation or update. In step 1234, universal model builder 1038 initializes candidate model 1039 for creation or updating and deployment to platform predictive intelligence model 1046. In step 1236, universal model builder 1038 trains and tests candidate model 1039. Such training and testing 1236 may comprise model training, model validation, model cross-validation and model testing. Model training and testing 1236 of an embodiment of risk/reward scoring system 1000 may, in the case of an update to platform predictive intelligence model 1046 employ incremental learning, wherein recently acquired entrant data and features extracted therefrom not previously used to train and test platform predictive intelligence model 1046 is now used to incrementally train and update candidate model 1039. Alternatively, in another embodiment, universal model builder 1038 in model training and testing step 1236 may use a comprehensive set of entrant data and features extracted therefrom which may comprise entrant data and features extracted therefrom that was previously used to train and test platform predictive intelligence model 1046 in addition to entrant data and features extracted therefrom that is newly acquired and not previously used, to train and test candidate model 1039 for deployment as platform predictive intelligence model 1046. Of course, in the case of a never previously created platform predictive intelligence model 1046, all entrant data and features extracted therefrom will be new and not previously used with regard to platform predictive intelligence model 1046. Model training and testing 1236 may be an iterative process based on results of testing. Once model training and testing 1236 has concluded, step 1238 checks if candidate model 1039 meets quality guidelines. If such quality guidelines are met, then candidate model 1039 may be deployed to platform predictive intelligence model 1046 in step 1240. If candidate model 1039 does not meet quality guidelines, then the model creation or update process 1230 is failed in step 1242, and candidate model 1039 may not be deployed to platform predictive intelligence model 1046.

FIG. 12C depicts an exemplary flow diagram of a process 1250 to create or update an application-specific risk/reward scoring model 1052 for risk/reward scoring system 1000, also referred to as a modeling process, which may comprise model training, model validation, model cross-validation and model testing. Referring to FIG. 12C, FIG. 10A and FIG. 10B, as additional data is acquired by entrant data manager 1010 and stored in entrant data profiles database 1012, and further processed by feature extraction engine 1020 and stored in entrant feature profiles database 1028, modeling process 1050 can be initiated periodically such that universal modeler 1030 updates an application-specific risk/reward model comprised in application-specific models database 1054 periodically for use as an updated risk/reward scoring model 1052. To maintain application-specific models representing, at least in part, entrant data and/or features extracted therefrom currently comprised within the risk/reward scoring system 1000, modeling process 1250 can be initiated upon at least one of a plurality of events. Such events may comprise but are not limited to, the acquisition of additional entrant data and/or features extracted therefrom relating to an application-specific risk/reward model exceeding a predetermined percentage portion of the total entrant data and/or features extracted therefrom relating to the application-specific risk/reward model within the system 1000, the acquisition of additional entrant data and/or features extracted therefrom relating to an application-specific risk/reward model exceeding a predetermined amount, the expiration of a predetermined period of time since the last update of a given application-specific risk/reward scoring model, a quality assurance initiated update for a given application-specific risk/reward scoring model, a newly defined application-specific model, newly defined or redefined entrant features for a given application-specific risk/reward scoring model or platform predictive intelligence model, or, newly defined or redefined evaluative considerations or evaluative measures for a given application-specific risk/reward scoring model or relating to a platform predictive intelligence vector. Alternatively, process 1250 can be a continual process, such that the process repeats after completion.

Modeling process 1250 begins in step 1252 with the start of a candidate model 1039 creation or update. In step 1254, universal model builder 1038 validates platform predictive intelligence model 1046 is current, such that entrant profiles to be used to create or update the candidate model 1039 have been sufficiently reflected in the platform model 1046. If not, in step 1256, universal model builder 1038 updates platform predictive intelligence model 1046 using process 1230 of FIG. 12B, otherwise processing proceeds to step 1258. In step 1258, universal model builder 1038A loads model builder platform model 1038B and initializes candidate model 1039 for creation or updating and deployment to application-specific models database 1054. In step 1260, universal model builder 1038 trains and tests candidate model 1039. Such training and testing 1260 may comprise model training, model validation, model cross-validation and model testing. Model training and testing 1260 of an embodiment of risk/reward scoring system 1000 may, in the case of an update to an application-specific model comprised in application-specific models database 1054, employ incremental learning, wherein recently acquired entrant data and features extracted therefrom not previously used to train the application-specific model is now used to incrementally train and update candidate model 1039. Alternatively, in another embodiment, universal model builder 1038 in model training and testing step 1260 may use a comprehensive set of entrant data and features extracted therefrom which may comprise entrant data and features extracted therefrom that was previously used to train and test the application-specific model in addition to entrant data and features extracted therefrom that is newly acquired and not previously used, to train and test candidate risk/reward model 1039 for deployment as an application-specific model. Of course, in the case of a never previously created application-specific model, all entrant data and features extracted therefrom will be new and not previously used with regard to the application-specific model. Model training and testing 1260 may be an iterative process based on results of testing. Once model training and testing 1260 has concluded, step 1262 checks if candidate application-specific model 1039 meets quality guidelines. If such quality guidelines are met, then candidate application-specific model 1039 may be deployed to application-specific models database 1054 in step 1264. If candidate application-specific model 1039 does not meet quality guidelines, then the model creation or update process 1250 is failed in step 1266, and candidate risk/reward model 1039 may not be deployed to application-specific models database 1054.

### Risk/Reward Scoring in Example Application-Specific Embodiments

Example application specific embodiments for risk/reward scoring may include, for example, unescorted access to listed real estate property, pet sitting services and senior sitting services, to name a few example applications. Each application may have subscribed evaluating entities (subscribers) of the risk/reward scoring service such that potential transactional entities (entrants/applicants) may be scored and evaluated in view of the potential application-specific transaction.

In an embodiment, a risk/reward scoring system, such as risk/reward scoring system 1000 of FIG. 10A may be used to score potential buyers/lessees (applicants) for unescorted access to the property, thereby making the property more available by removing the dependency for having an escort available and streamlining the qualification process. As such, a subscriber, such as a property owner, property management company, realtor and the like, responsible for selling or leasing the property, may reduce their costs and efforts required to list and show the property by subscribing to a risk/reward scoring service. In an example embodiment, an applicant may create an account with the subscriber and/or the scoring service in order to be scored and considered for unescorted real estate access. In an embodiment, the account can be created and accessed via an application on a smartphone and can be preexisting prior to arriving at a property or the application can be downloaded and the account created after arriving at the property.

When an applicant requests unescorted access, a risk/reward score request process, such as process 1200 or FIG. 12A may begin in step 1202. If the applicant already has an account and entrant ID will be present in 1204 and the process may proceed to step 1208, otherwise an account may be created and a new entrant ID may be created in step 1206 and then proceed to step 1208. Process 1200 proceeds as discussed earlier to create or update the anonymity profile (step 1208), entrant data profile (step 1210) and entrant feature profile (step 1212) and generate the entrant vector (step 1214). In step 1216, multi-application risk/reward scoring engine 1050 (FIG. 10A) of modeling and scoring section 1006 loads an application-specific risk reward scoring model 1046 from application-specific models database 1054 for the unescorted real estate access application. In step 1218, risk/reward scoring model 1052 of multi-application risk/reward scoring engine 1050 generates a risk/reward score which may comprise a plurality of scores of various evaluative considerations and/or evaluative measures, some of which may be statistical, probabilistic or predictive in nature and comprise measures of potential outcomes for a potential unescorted real estate access transaction in view of a transactional relationship with the applicant. In step 1220, risk/reward score formatter 1056 formats the risk/reward score generated by risk/reward scoring model 1052, wherein such format may be specified by format rules database 1058 as indicated by the subscriber and unescorted real estate access application. Lastly, in step 1222, multi-application risk/reward scoring engine 1050 sends a risk/reward score response 1008. The subscriber may then provide or deny unescorted access based on the score result. Such access, if provided, can be accomplished, for example, via remote commands sent by the subscriber to an electronic lock box or electronic door lock at the property via the applicant's smartphone.

In an embodiment, a risk/reward scoring system, such as risk/reward scoring system 1000 of FIG. 10A may be used to score potential pet sitters (applicants) for pet sitting services. As such, a subscriber, such as a pet sitting service can obtain risk/reward scores for potential applicants for customers of the pet sitting service. In an example embodiment, an applicant may create an applicant account with the subscriber and/or the scoring service in order to be scored and considered for one or more potential pet sitting engagements. An applicant may provide entrant data and data permissions such that the subscribing pet sitting service and risk/reward scoring service may build an entrant data profile from the entrant data and third party data sources, wherein the entrant data profile may be usable for generating a risk/reward score for the applicant in a transaction for a pet sitting engagement. In an embodiment, the applicant account may be created and accessed via an application on a smartphone. Customers of the pet sitting service may create customer accounts which indicate information about the type and nature of pet sitting services they want to obtain, such as the number and types of pets, size of pets, age of pets, special needs of pets (special care and medical needs), time of day services are needed, days the services are needed, the location of the service (in pet owner's home or at sitter's home), other services such as pet walking, pet bathing, etc.

An applicant can list their availability on the application where customers of the pet sitting service can then select the applicant for a potential pet sitting transaction, wherein the selection may generate a risk/reward score request for the applicant for a potential pet sitting transaction with the pet owner. A risk/reward score request process, such as process 1200 or FIG. 12A may begin in step 1202. In this embodiment as described above, the applicant already has an account and an entrant ID will be present in 1204 and the process may proceed to step 1208. Process 1200 may update the anonymity profile (step 1208), entrant data profile (step 1210) and entrant feature profile (step 1212) and generate the entrant vector (step 1214). In step 1216, multi-application risk/reward scoring engine 1050 (FIG. 10A) of modeling and scoring section 1006 loads an application-specific risk reward scoring model 1046 from application-specific models database 1054 for the pet sitting application. In step 1218, risk/reward scoring model 1052 of multi-application risk/reward scoring engine 1050 generates a risk/reward score which may comprise a plurality of scores of various evaluative considerations and/or evaluative measures, some of which may be statistical, probabilistic or predictive in nature and comprise measures of potential outcomes for a potential pet sitting transaction in view of a transactional relationship with the applicant and pet owner. In step 1220, risk/reward score formatter 1056 formats the risk/reward score generated by risk/reward scoring model 1052, wherein such format may be specified by format rules database 1058 as indicated by the subscriber and pet sitter transaction. Lastly, in step 1222, multi-application risk/reward scoring engine 1050 sends a risk/reward score response 1008. The subscriber may then allow or deny the pet sitter transaction based on the score result.

In an embodiment, a risk/reward scoring system, such as risk/reward scoring system 1000 of FIG. 10A may be used to score potential senior sitters (applicants) for senior sitting services. As such, a subscriber, such as a senior sitting service can obtain risk/reward scores for potential applicants for customers of the senior sitting service. In an example embodiment, an applicant may create an applicant account with the subscriber and/or the scoring service in order to be scored and considered for one or more potential pet senior engagements. An applicant may provide entrant data and data permissions such that the subscribing senior sitting service and risk/reward scoring service may build an entrant data profile from the entrant data and third party data sources, wherein the entrant data profile may be usable for generating a risk/reward score for the applicant in a transaction for a senior sitting engagement. In an embodiment, the applicant account may be created and accessed via an application on a smartphone. Customers of the senior sitting service may create customer accounts which indicate information about the type and nature of senior sitting services they want to obtain, special needs (special care and medical needs), time of day services are needed, days the services are needed, the location of the service and the like.

An applicant can list their availability on the application where customers of the senior sitting service can then select the applicant for a potential senior sitting transaction, wherein the selection may generate a risk/reward score request for the applicant for a potential senior sitting transaction with the senior. A risk/reward score request process, such as process 1200 or FIG. 12A may begin in step 1202. In this embodiment as described above, the applicant already has an account and an entrant ID will be present in 1204 and the process may proceed to step 1208. Process 1200 may update the anonymity profile (step 1208), entrant data profile (step 1210) and entrant feature profile (step 1212) and generate the entrant vector (step 1214). In step 1216, multi-application risk/reward scoring engine 1050 (FIG. 10A) of modeling and scoring section 1006 loads an application-specific risk reward scoring model 1046 from application-specific models database 1054 for the senior sitting application. In step 1218, risk/reward scoring model 1052 of multi-application risk/reward scoring engine 1050 generates a risk/reward score which may comprise a plurality of scores of various evaluative considerations and/or evaluative measures, some of which may be statistical, probabilistic or predictive in nature and comprise measures of potential outcomes for a potential senior sitting transaction in view of a transactional relationship with the applicant and the senior. In step 1220, risk/reward score formatter 1056 formats the risk/reward score generated by risk/reward scoring model 1052, wherein such format may be specified by format rules database 1058 as indicated by the subscriber and senior sitter transaction. Lastly, in step 1222, multi-application risk/reward scoring engine 1050 sends a risk/reward score response 1008. The subscriber may then allow or deny the senior sitter transaction based on the score result.

### Self-Sovereign Identity (SSI) Services

In an embodiment, a risk/reward scoring system, such as risk/reward scoring system 1000 of FIG. 10A may comprise SSI services, such that risk/reward scoring system 1000 is a SSI credential issuer and/or a SSI credential verifier, and may per entrant permissions provided by an entrant, receive credentials from an entrant and verify such credentials as part of building an entrant data profile, an entrant feature profile and/or an entrant vector, and/or a generation of a risk/reward score, and/or modeling of a platform model or an application-specific model. In an embodiment, a risk/reward system 1000 may provide entrant risk/reward scores and/or verify entrant credentials for subscribers which may be evaluating potential transactions with such entrants.

### Feedback Incentives

In an embodiment, a risk/reward scoring system, such as risk/reward scoring system 1000 of FIG. 10A, may provide incentives for subscribers to provide transaction feedback by offering service fee discounts based on subscribers providing feedback relative to transaction outcomes, such that risk/reward system 1000 may improve its platform and application modeling by capturing more robust outcomes data and building more robust entrant data and feature profiles for improved modeling and scoring. In an embodiment, subscribers can receive credit or service discounts for maintained rating pages, for example, pet sitter applicant or senior sitter applicant ratings pages, and providing risk/reward system 1000 access to data comprised by such ratings pages. In an embodiment, credit or service discount incentives may be offered for subscribers who provide itemized feedback on transactions, such as credit or discount levels based on percentage of transactions with provided feedback and/or compliance with providing feedback on transactions flagged for feedback by risk/reward system 1000.

While the principles of the disclosure have been described above in connection with specific methods and systems, it is to be understood that this description is made only by way of example and not limitation on the scope of the disclosure. Although several embodiments have been illustrated and described in detail, it will be recognized that substitutions and alterations are possible without departing from the spirt and scope of the appended claims. Modifications, additions, or omission may be made to the methods described above without departing from the scope of the disclosure. Additionally, the steps may be performed in any suitable order without departing from the scope as well.

The foregoing disclosure provides illustration and description, but is not intended to be exhaustive or to limit the embodiments to the precise form disclosed. Modifications and variations are possible in light of the above disclosure or may be acquired from practice of the embodiments.

As used herein, the term component is intended to be broadly construed as hardware, software, firmware, and/or combinations of hardware, software or firmware. As used herein, the term module is intended to be broadly construed as hardware, software or firmware, and/or combinations of hardware, software or firmware.

It will be apparent that systems and/or methods, described herein, may be implemented in different forms of hardware, software, firmware, or combinations of hardware, software or firmware. The actual specialized control hardware or software code used to implement these systems and/or methods is not limiting of the embodiments. Thus, the operation and behavior of the systems and/or methods were described herein without reference to specific software code, as it is understood that software and hardware can be designed to implement the systems and/or methods based on the description herein.

Even though particular combinations of features are recited in the claims and/or disclosed in the specification, these combinations are not intended to limit the disclosure of possible embodiments. In fact, many of these features may be combined in ways not specifically recited in the claims and/or disclosed in the specification. Although each dependent claim listed below may directly depend on only one claim, the disclosure of possible embodiments includes each dependent claim in combination with every other claim in the claim set unless such combination is contradictory to the disclosure.

No element, act, or instruction used herein should be construed as required, critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more” unless it is stated or implicit that the set may be a null set. Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A scoring system comprising:
one or more servers comprising one or more processors and configured to communicate over a communications network and communicate with a subscriber system, wherein the subscriber system comprises one or more processors and is configured to communicate over a communications network and communicate with the scoring system;
one or more databases accessible by the one or more servers, wherein the one or more databases comprise a plurality of entrant feature profiles representing entrants in the scoring system, wherein an entrant feature profile comprises facts and/or behavioral traits concerning an entrant, and entrant outcomes, wherein entrant outcomes comprise previous actions and/or results of transactional relationships of the entrant;
a machine learning based modeler configured to generate a model modeling a relationship between entrant features and entrant outcomes for a plurality of entrants; and
a scoring engine configured to generate a score for an entrant based on at least a portion of the entrant feature profile of the entrant and the model, wherein the score is a measure of potential outcomes, wherein the subscriber system can request and/or receive a score for an entrant from the scoring system.

2. The system of claim 1, wherein the one or more databases further comprise a plurality of entrant data profiles associated with entrants of the scoring system and useable to create one or more of the plurality of entrant feature profiles.

3. The system of claim 2, wherein the one or more servers are further configured to communicate with a user device comprising one or more processors and configured to communicate with the scoring system, wherein a user of the user device can submit entrant data for inclusion in an entrant data profile of the user and/or submit permissions permitting the one or more servers to communicate with a third party database to acquire entrant data for inclusion in an entrant data profile of the user.

4. The system of claim 2, wherein the subscriber system is further configured to communicate with a user device comprising one or more processors and configured to communicate with the subscriber system, wherein a user of the user device can submit entrant data to the subscriber system for forwarding to the scoring system by the subscriber system, for inclusion in an entrant data profile of the user, and/or submit permissions to the subscriber system for forwarding to the scoring system, permitting the one or more servers to communicate with a third party database to acquire entrant data for inclusion in an entrant data profile of the user.

5. The system of claim 1, wherein the modeler is further configured to generate a candidate model, test the candidate model and deploy the candidate model for use as the model in providing scores to the subscriber if the candidate model meets one or more quality assurance requirements.

6. The system of claim 1, wherein the model is one of a plurality of application-specific models and the scoring system can generate scores using two or more models to generate different types of scores for different applications.

7. The system of claim 6, wherein the one or more databases comprise an application-specific models database.

8. The scoring system of claim 1, wherein:
the model is one of a plurality of models;
one model of the plurality of models is a platform model; and
two or more models of the plurality of models are application-specific models, wherein:
entrant outcomes are associated with one or more types of scoring applications;
the modeler models the platform model using entrant outcomes associated with all types of scoring applications; and
the modeler models an application-specific model by modeling the output of the platform model to the outcomes associated with the scoring application

9. The system of claim 8, wherein the scoring engine generates the score using the platform model as a first tier and the application-specific model associated with the scoring application of the score as a second tier, wherein the output of the platform model is input into the application-specific model and the score is output from the application-specific model.

10. The system of claim 1, wherein the one of more databases comprise an anonymity profiles database comprising permissions specifying permitted access to, and usage of data related to an entrant.

11. A method for generating a score for an entrant for a potential transaction, the method comprising:
providing a scoring system comprising:
one or more servers comprising one or more processors and configured to communicate over a communications network and communicate with a subscriber system, wherein the subscriber system comprises one or more processors and is configured to communicate over a communications network and communicate with the scoring system;
one or more databases accessible by the one or more servers, wherein the one or more databases comprise a plurality of entrant feature profiles representing entrants in the scoring system, wherein an entrant feature profile comprises facts and/or behavioral traits concerning an entrant, and entrant outcomes, wherein entrant outcomes comprise previous actions and/or results of transactional relationships of the entrant;
a machine learning based modeler configured to generate a model modeling a relationship between entrant features and entrant outcomes for a plurality of entrants; and
a scoring engine configured to generate a score for an entrant based on at least a portion of the entrant feature profile of the entrant and the model, wherein the score is a measure of potential outcomes, wherein the subscriber system can request and/or receive a score for an entrant from the scoring system;
generating a model modeling a relationship between entrant features and entrant outcomes for a plurality of entrants;
receiving a request from the subscriber system to score an entrant having an entrant feature profile comprised by the one or more databases;
generating a score for the entrant based at least on a portion of the entrant feature profile of the entrant and the model.
sending the score in to the subscriber.

12. The method of claim 11, wherein the provided one or more databases further comprise a plurality of entrant data profiles associated with entrants of the scoring system, the method further comprising creating one or more of the plurality of entrant feature profiles from at least a portion of the plurality of entrant data profiles.

13. The method of claim 12, wherein the one or more servers are further configured to communicate with a user device comprising one or more processors and configured to communicate with the scoring system, the method further comprising receiving from a user of the user device entrant data for inclusion in an entrant data profile of the user and/or receiving from the user permissions permitting the one or more servers to communicate with a third party database to acquire entrant data for inclusion in an entrant data profile of the user.

14. The method of claim 12, wherein the subscriber system is further configured to communicate with a user device comprising one or more processors and configured to communicate with the subscriber system, the method further comprising receiving from the subscriber forwarded entrant data sent to the subscriber by a user of the user device for inclusion in an entrant data profile of the user, and/or receiving from the subscriber forwarded permissions sent to the subscriber by the user, permitting the one or more servers to communicate with a third party database to acquire entrant data for inclusion in an entrant data profile of the user.

15. The method of claim 11, wherein the modeler is further configured to generate a candidate model, test the candidate model and deploy the candidate model for use as the model in providing scores to the subscriber if the candidate model meets one or more quality assurance requirements, the method further comprising generating a candidate model, testing the candidate model, determining that the candidate model meets one or more quality assurance requirements and deploying the candidate model for use in the scoring system for providing scores to the subscriber.
